(19) United States
(12) Patent Application Publication
(10) Pub. No.: US 2002/0079802 A1
(43) Pub. Date: Jun. 27, 2002

(54) Electron-emitting device, cold cathode field emission device and method for production thereof, And cold cathode field emission display and method for production thereof

(76) Inventors: Kouji Inoue, Kanagawa (JP); Masakazu Muroyama, Kanagawa (JP); Takao Yagi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/939,772

(22) Filed: Aug. 28, 2001

(30) Foreign Application Priority Data
Aug. 31, 2000 (JP) P2000-262753
Aug. 9, 2001 (JP) P2001-241676

(51) Int. Cl. H01J 1/62; H01J 63/04

(52) U.S. Cl. 313/309; 313/336; 313/351; 313/495

(57) ABSTRACT

A cold cathode field emission device comprising a cathode electrode formed on a support member, and a conical electron emitting portion made of carbon and formed on the cathode electrode.

### BACKGROUND OF THE INVENTION AND RELATED ART STATEMENT

The present invention relates to an electron-emitting device, a cold cathode field emission device and a method for the production thereof, and it also relates to a cold cathode field emission display and a method for the production thereof.

In the fields of displays for use in television receivers and information terminals, studies have been made for replacing conventionally mainstream cathode ray tubes (CRT) with flat-panel displays which are to comply with demands for a decrease in thickness, a decrease in weight, a larger screen and a high fineness. Such flat panel displays include a liquid crystal display (LCD), an electroluminescence display (ELD), a plasma display panel (PDP) and a cold cathode field emission display (FED). Of these, a liquid crystal display is widely used as a display for an information terminal. For applying the liquid crystal display to a floor-type television receiver, however, it still has problems to be solved concerning a higher brightness and an increase in size.

When an electric field having a value greater than a certain threshold value is applied to a metal, a semiconductor or the like present in vacuum, electrons pass through an energy barrier in the vicinity of the surface of the metal, the semiconductor, etc., due to a quantum tunnel effect, and the electrons come to be emitted into a vacuum space at ordinary temperature (room temperature). Such electron emission based on the above principle is called cold cathode field emission or field emission. In recent years, there have been and are proposed flat type cold cathode field emission displays or field emission displays (FED) in which the above principle of field emission is applied to an image display. Such field emission displays advantageously have a high brightness and attain low power consumption, so that they are expected to be promising as image displays that can supersede conventional cathode ray tubes (CRT).

FIG. 21 shows an example of constitution of a cold cathode field emission display (to be sometimes referred to as “display” hereinafter) using cold cathode field emission devices (to be sometimes referred to as “field emission device” hereinafter). The field emission device shown in FIG. 21 is a so-called Spindt type field emission device having a conical electron emitting portion. Such a field emission device comprises a cathode electrode 211 formed on a support member 210, an insulating layer 212 formed on the support member 210 and the cathode electrode 211, a gate electrode 213 formed on the insulating layer 212, an opening portion 214 formed in the gate electrode 213 and the insulating layer 212, and a conical electron emitting portion 215 formed on the cathode electrode 211 positioned in a bottom of the opening portion 214. Generally, the cathode electrode 211 and the gate electrode 213 are formed in the form of a stripe each in directions in which projection images of these two electrodes cross each other at right angles. Generally, a plurality of field emission devices are arranged in a region (corresponding to one pixel, the region will be called an “overlapped region” hereinafter) where the projection images of the above two electrodes overlap. Further, generally, such overlapped regions are arranged in the form of a matrix within an effective field (which works as an actual display portion) of a cathode panel CP.

An anode panel AP comprises a substrate 20, a phosphor layer 21 which is formed on the substrate 20 and has a predetermined pattern, and an anode electrode 23 formed thereon. On the substrate 20 between one phosphor layer 21 and another phosphor layer 21, a black matrix 22 is formed. One pixel is constituted of a group of the field emission devices arranged in the overlapped region of the cathode electrode 211 and the gate electrode 213 on the cathode panel CP side and the phosphor layer 21 which is opposed to the above group of the field emission devices and is on the anode panel AP side. In the effective field, such pixels are arranged on the order of hundreds of thousands to several millions.

The anode panel AP and the cathode panel CP are arranged such that the field emission devices and the phosphor layers 21 are opposed to each other, and the anode panel AP and the cathode panel CP are bonded to each other in their circumferential portions through a frame 24, whereby the display is produced. In an ineffective field (for example, ineffective field of the cathode panel CP) which surrounds the effective field and where a peripheral circuit for selecting pixels is formed, a through hole for vacuuming (not shown) is provided, and a tip tube (not shown) is connected to the through hole and sealed after vacuuming. That is, a space surrounded by the anode panel AP, the cathode panel CP and the frame 24 is in a vacuum state.

A relatively negative voltage is applied to the cathode electrode 211 from a cathode electrode control circuit 30, a relatively positive voltage is applied to the gate electrode 213 from a gate electrode control circuit 31, and a positive voltage having a higher level than the voltage applied to the gate electrode 213 is applied to the anode electrode 23 from an anode electrode control circuit 32. When such a display is used for displaying on its screen, a scanning signal is inputted to the cathode electrode 211 from the cathode electrode control circuit 30, and a video signal is inputted to the gate electrode 213 from the gate electrode control circuit 31. Due to an electric field generated when a voltage is applied between the cathode electrode 211 and the gate electrode 213, electrons are emitted from the electron emitting portion 215 on the basis of a quantum tunnel effect, and the electrons are attracted toward the anode electrode 23 and collide with the phosphor layer 21. As a result, the phosphor layer 21 is excited to emit light, and a desired image can be obtained. That is, the working of the display is controlled, in principle, by a voltage applied to the gate electrode 213 and a voltage applied to the electron emitting portion 215 through the cathode electrode 211.

The outline of the method of manufacturing the conventional Spindt-type electron emission device will be explained hereinafter. In principle, this method is a method of forming the conical electron emitting electrode 215 by vertical deposition of a metal material. That is, vaporized particles perpendicularly enter the opening portion 214. The amount of the vaporized particles which reach the bottom of the opening portion 214 is gradually decreased by utilizing the shielding effect of an overhanging deposit formed around the opening portion 214, so that the electron emitting electrode 215 as a conical deposit is formed in a self-aligned manner. This embodiment employs a method of pre-forming a pee-off layer 217 on the gate electrode 213 for easing the removal of the unnecessary overhanging deposit, and the method will be explained below with reference FIGS. 22A, 22B, 22C, 23A and 23B which are schematic partial end vies of a support member, etc.

[Step-10]

First, the cathode electrode 211 made of niobium (Nb) is formed on the support member 210 made, for example, of glass, and the insulating layer 212 made of SiO₂ is formed on the entire surface, and the gate electrode 213 in the form of a stripe is formed on the insulating layer 212. The formation of the gate electrode 213 can be carried out by, for example, a sputtering method, a lithographic method and a dry-etching method.

[Step-20]

Then, a resist layer 216 which works as an etching mask is formed on the insulating layer 212 and the gate electrode 213 by lithography (see FIG. 22A). Then, a first opening portion 214A is formed in the gate electrode 213 by RIE (reactive ion etching) method and a second opening portion 214B communicating with the first opening portion 214A is formed in the insulating layer 212. These first opening portion 214A and second opening portion 214B will be sometimes generically referred to as “opening portion 214”, hereinafter. The cathode electrode 211 is exposed in a bottom of the opening portion 214. Then, the resist layer 216 is removed by an ashing method, whereby the structure shown in FIG. 22B can be obtained.

[Step-30]

Then, an electron emitting portion 215 is formed on the cathode electrode 211 exposed in the bottom of the opening portion 214. Specifically, aluminum is obliquely vapor-deposited to form a peel-off layer 217. In this case, the incidence angle of the vaporized particles to a normal of the support member 210 is set at a fully large angle, whereby the peel-off layer 217 can be formed on the gate electrode 213 and the insulating layer 212 almost without depositing aluminum in the bottom of the opening portion 214. The peel-off layer 217 extends from the opening end portion of the opening portion 214 so as to form eaves, and the opening portion 214 is therefore substantially decreased in diameter (see FIG. 22C).

[Step-40]

Then, for example, molybdenum (Mo) is vertically vapor-deposited on the entire surface. In this case, as an electric conductive material layer 218 made of molybdenum having an overhanging form grows on the peel-off layer 217, the substantial diameter of the opening portion 214 is decreased, so that the vaporized particles which contributes to deposition on the bottom of the opening portion 214 gradually come to be limited to particles passing the center of the opening portion 214. As a result, a conical deposit is formed on the bottom of the opening portion 214 as shown in FIG. 23A, and the conical deposit made of molybdenum constitutes the electron emitting portion 215.

[Step-50]

Then, the peel-off layer 217 is peeled off from the surface of the insulating layer 212 and the gate electrode 213 by an electrochemical process and a wet process, and the electrically conductive material layer 218 above the insulating layer 212 and the gate electrode 213 is selectively removed. As a result, the conical electron emitting portion 215 can be retained on the cathode electrode 211 positioned in the bottom of the opening portion 214 as shown in FIG. 23B. In the above method of forming the electron emitting portion 215, essentially, one electron emitting portion 215 is formed in one opening portion 214.

In the above display constitution, it is effective to sharpen the top end portion of the electron emitting portion for attaining a large current of emitted electrons at a low driving voltage, and from this viewpoint, the electron emitting portion 215 of the above Spindt type field emission device can be said to have excellent performances. However, the formation of the conical electron emitting portion 215 requires advanced processing techniques, and with an increase in the area of the effective field, it is beginning to be difficult to form the electron emitting portions 215 uniformly all over the effective field since the number of the electron emitting portions 215 totals up to tens of millions in some cases. That is, it is very difficult to form the electrically conductive material layer 218 having a uniform quality and a uniform thickness on the entire support member having a large area by a vertical deposition method or to form the peel-off layer 217 having uniform dimensions and having the form of eaves by an oblique deposition method, and some in-plane fluctuation or some fluctuation among lots is inevitable. The above fluctuation causes fluctuation in image display characteristics of a display such as brightness of images. Further, when the peel-off layer 217 formed on a large area is removed, its residue causes the cathode panel CP to be contaminated, and there is caused a problem that the manufacturing yield of displays is decreased.

There has been therefore proposed a so-called flat-surface type field emission device which uses a flat electron emitting portion exposed in a bottom of an opening portion without using the conical electron emitting portion. The electron emitting portion of the flat-surface type field emission device is formed on a cathode electrode, and it is composed of a material having a lower work function than a material constituting the cathode electrode for achieving a high current of emitted electrons even if the electron emitting portion is flat. In recent years, it has been proposed to use a carbon material as the above material. The carbon-containing material has a low electric field threshold as compared with any refractory metal and has high electron emission efficiency. Further, it can be changed in the form of bonding like diamond, graphite and carbon nano-tubes.

For example, in Lecture No. 15p-P-13 on page 480 of preprints of No. 59 Applied Physics Society Lectures (1998), a DLC (diamond-like carbon) thin film is proposed. When a carbon material is formed into a thin film, a method for processing (patterning) the thin film is required. As a patterning method therefor, for example, Lecture No. 16p-N-11 on page 489 of the above preprints (1998) proposes an ECR plasma processing of a diamond thin film with oxygen gas as an etching gas. Generally, an SiO₂-containing material is used as a mask for etching in the plasma processing of a diamond thin film.

Further, in Lecture No. 2p-H-6 on page 631 of preprints of No. 60 Applied Physics Society Lectures (1999) (to be referred to as Literature-1), there is disclosed a flat-surface-structured electron emitter obtained by scratch-processing a surface of a titanium thin film formed on a quartz substrate by an electron beam deposition method, with a diamond powder, then patterning the titanium thin film to form a several μm gap in a central portion, and then, forming a non-doped diamond thin film on the titanium thin film. In Lecture No. 2p-H-11 on page 632 of preprints of No. 60 Applied Physics Society Lectures (1999) (to be referred to as Literature-2), there is disclosed a method in which a carbon nano-tube is formed on a quartz glass provided with a metal cross line.

JP-A-2000-57934 discloses a carbon-based ultrafine cold cathode and a method of producing the same, in which a carbon nano-tube or amorphous carbon is directly deposited on a surface of a substrate by an electric-field-applied plasma CVD method.

When a carbon film such as DLC is plasma-etched with oxygen gas with using a resist layer as an etching mask, a deposition product of a (COₓ)- or (CFₓ)-based carbon polymer is generated as a reaction byproduct in the etching reaction system. When a deposition product is generated in the etching reaction system in the plasma etching, generally, the deposition product is formed on a side wall surface of a resist layer which side wall surface has a low ion incidence probability or is formed on a processed end surface of a material being etched, to form a so-called side wall protective film, and it contributes to accomplishment of the form obtained by anisotropic processing a material being etched. When oxygen gas is used as an etching gas, however, the side wall protective film composed of the carbon polymer is removed by oxygen gas upon the formation thereof. Further, when oxygen gas is used as an etching gas, the resist layer is worn to a great extent. For these reasons, in the conventional oxygen plasma process of a diamond thin film, the pattern transfer difference of the diamond thin film from the mask is large, and an anisotropic processing is also difficult.

Further, in techniques disclosed in Literature-1 and Literature-2, a carbon film is formed on a metal thin layer. However, the carbon film is formed in any portion of the metal thin layer, so that it cannot be said that it is practical to apply these techniques, for example, to the production of the cold cathode field emission device. It is also difficult to pattern a carbon film for forming the carbon film as desired, as has been described above.

In the technique disclosed in JP-A-2000-57934, a carbon nano-tube is formed, and its top end portion is desired to be sharp in view of electron emission in a lower electric field.

Further, a field emission device composed of diamond, graphite or a carbon nano-tube has a low electric field threshold and has high electron emission efficiency. Since, however, these are synthesized at a very high temperature of as high as over 500° C., it is difficult to use a less-expensive glass substrate.

### OBJECT AND SUMMARY OF THE INVENTION

It is therefore an object of the present invention to provide an electron-emitting device and a cold cathode field emission device that permit electron emission in a far lower electric field, make it possible to decrease the temperature to be employed for forming an electron emitting portion and have the electron emitting portion made of carbon and reliably formed in a desired portion of the electrically conductive layer or a cathode electrode, and a method of production thereof, and a cold cathode field emission display having such cold cathode field emission devices incorporated and a method of production thereof.

An electron-emitting device of the present invention for achieving the above object has a conical electron emitting portion made of carbon on an electrically conductive layer.

In the electron-emitting device of the present invention, preferably, an electron-emitting-portion-forming layer is formed between the electrically conductive layer and the electron emitting portion for selectively forming the electron emitting portion.

A cold cathode field emission device of the present invention for achieving the above object comprises;

(A) a cathode electrode formed on a support member, and

(B) a conical electron emitting portion made of carbon and formed on the cathode electrode.

A cold cathode field emission display of the present invention for achieving the above object comprises a plurality of pixels,

each pixel being composed of a cold cathode field emission device formed on a support member, an anode electrode and a phosphor layer, said anode electrode and said phosphor layer being formed on a substrate to be opposed to the cold cathode field emission device,

said cold cathode field emission device comprising;

(A) a cathode electrode formed on the support member, and

(B) a conical electron emitting portion made of carbon and formed on the cathode electrode.

In the cold cathode field emission display of the present invention, when the distance between the anode electrode and the electron emitting portion is sufficiently small, electrons are emitted from the electron emitting portion on the basis of a quantum tunnel effect under an electric field formed by the anode electrode, and the electrons are attracted toward the anode electrode to collide with the phosphor layer. In a cold cathode field emission display having a gate electrode to be explained below, electrons are emitted from the electron emitting portion on the basis of a quantum tunnel effect under an electric field formed by the gate electrode, and the electrons are attracted toward the anode electrode to collide with the phosphor layer.

In the cold cathode field emission device or the cold cathode field emission display of the present invention, there may be employed a constitution in which the cold cathode field emission device further has a gate electrode having an opening portion, and the electron emitting portion is formed on that portion of the cathode electrode which is positioned in the bottom of the opening portion. The above constitution will be referred to as “first constitution” for convenience hereinafter.

Alternatively, the cold cathode field emission device or the cold cathode field emission display of the present invention may employ another constitution. That is, in the cold cathode field emission device, an insulating layer is formed on the support member and the cathode electrode, a gate electrode is formed on the insulating layer, a second opening portion communicating with an opening portion formed in the gate electrode is formed in the insulating layer, and the electron emitting portion is exposed in the bottom of the second opening portion. The above constitution will be referred to as “second constitution” for convenience hereinafter.

In the cold cathode field emission device or the cold cathode field emission display of the present invention, preferably, an electron-emitting-portion-forming layer is formed between the cathode electrode and the electron emitting portion in the cold cathode field emission device. In this case, there may be employed a constitution in which the cold cathode field emission device further has a gate electrode having an opening portion, the electron-emitting-portion-forming layer is formed at least on the surface of that portion of the cathode electrode which is positioned in the bottom of the opening portion, and the electron emitting portion is formed on the electron-emitting-portion-forming layer. The above constitution will be referred to as “third constitution” for convenience hereinafter. Alternatively, there may be employed a constitution in which an insulating layer is formed on the support member and the cathode electrode, the gate electrode is formed on the insulating layer, a second opening portion communicating with the opening portion formed in the gate electrode is formed in the insulating layer, and the electron emitting portion is exposed in the bottom of the second opening portion. The above constitution will be referred to as “fourth constitution” for convenience hereinafter.

According to a first aspect of the present invention for achieving the above object, there is provided a method for producing a cold cathode field emission device, which comprises the steps of;

(a) forming a cathode electrode on a support member, and

(b) selectively forming a conical electron emitting portion made of carbon on the surface of the cathode electrode.

According to a first aspect of the present invention for achieving the above object, there is provided a method for producing a cold cathode field emission display, to which the method for producing a cold cathode field emission device according to the first aspect of the present invention is applied. That is, it is a method which comprises arranging a substrate having an anode electrode and a phosphor layer and a support member having a cold cathode field emission device such that the phosphor layer or the anode electrode and the cold cathode field emission device face each other and bonding the substrate and the support member in their circumferential regions,

wherein the cold cathode field emission device is formed by the steps of;

(a) forming a cathode electrode on the support member, and

(b) selectively forming a conical electron emitting portion made of carbon on the cathode electrode.

In the method for producing a cold cathode field emission device or the method for producing a cold cathode field emission display according to the first aspect of the present invention (these methods will be sometimes generically referred to as “production method according to the first aspect” hereinafter), there may be employed a constitution in which the above step (b) is followed by forming a gate electrode having an opening portion over the electron emitting portion. The above constitution will be referred to as “first constitution A” of the present invention for convenience.

Alternatively, in the production method according to the first aspect, there may be employed a constitution in which the method further comprises, between the above steps (a) and (b), the steps of;

forming an insulating layer on the support member and the cathode electrode,

forming a gate electrode having an opening portion on the insulating layer, and

forming, in the insulating layer, a second opening portion communicating with the opening portion formed in the gate electrode,

wherein the conical electron emitting portion made of carbon is formed on the cathode electrode positioned in the bottom of the second opening portion in the step (b). The above constitution will be referred to as “first constitution B” of the present invention for convenience.

Alternatively, in the production method according to the first aspect of the present invention, there may be employed a constitution in which the above step (b) is followed by the steps of;

forming an insulating layer on the support member and the electron emitting portion,

forming a gate electrode having an opening portion on the insulating layer, and

forming, in the insulating layer, a second opening portion which communicates with the opening portion formed in the gate electrode and in a bottom of which the electron emitting portion is exposed. The above constitution will be referred to as “first constitution C” of the present invention for convenience.

In the production method according to the first aspect of the present invention, from the viewpoints that the dissociation degree of a source gas used for the formation of the electron emitting portion is increased and that the conical electron emitting portion is reliably formed, preferably, the step of forming the conical electron emitting portion made of carbon is carried out on the basis of a plasma CVD method (chemical vapor deposition method) under a condition satisfying a plasma density of at least 10¹⁶m⁻³ (10⁷mm⁻³), preferably at least 10¹⁷m⁻³ (10⁸mm⁻³), more preferably at least 10¹⁹m⁻³ (10¹⁰mm⁻³) in a state where a bias voltage is applied to the support member. Otherwise, from the viewpoints that the dissociation degree of a source gas used for the formation of the electron emitting portion is increased and that the conical electron emitting portion is reliably formed, preferably, the step of forming the conical electron emitting portion made of carbon is carried out on the basis of a plasma CVD method under a condition satisfying an electron temperature of 1 to 15 eV, preferably 5 eV to 15 eV and an ion current density of 0.1 mA/cm² to 30 mA/cm², preferably, 5 mA/cm² to 30 mA/cm², in a state where a bias voltage is applied to the support member. In these cases, for satisfying the above conditions, the plasma CVD method is selected from an inductively coupled plasma CVD method, an electron cyclotron resonance plasma CVD method, a helicon wave plasma CVD method or a capacitively coupled plasma CVD method. In the step of forming the conical electron emitting portion made of carbon, the temperature for heating the support member can be set at 600° C. or lower, preferably at 500° C. or lower, more preferably at 400° C. or lower, still more preferably at 300° C. or lower. The temperature lower limit of heating the support member can be a temperature at which the conical electron emitting portion made of carbon can be formed.

According to a second aspect of the present invention for achieving the above object, there is provided a method for producing a cold cathode field emission device, which comprises the steps of;

(a) forming a cathode electrode on a support member,

(b) forming an electron-emitting-portion-forming layer on the cathode electrode, and

(c) forming a conical electron emitting portion made of carbon on the electron-emitting-portion-forming layer.

According to a second aspect of the present invention for achieving the above object, there is provided a method for producing a cold cathode field emission display, to which the method for producing a old cathode field emission device according to the second aspect of the present invention is applied. That is, it is a method which comprises arranging a substrate having an anode electrode and a phosphor layer and a support member having a cold cathode field emission device such that the phosphor layer or the anode electrode and the cold cathode field emission device face each other and bonding the substrate and the support member in their circumferential regions,

wherein the cold cathode field emission device is formed by the steps of;

(a) forming a cathode electrode on the support member,

(b) forming an electron-emitting-portion-forming layer on the cathode electrode, and

(c) forming a conical electron emitting portion made of carbon on the electron-emitting-portion-forming layer.

In the method for producing a cold cathode field emission device or the method for producing a cold cathode field emission display according to the second aspect of the present invention (these methods will be generically referred to as “production method according to the second aspect” hereinafter), there may be employed a constitution in which the method further comprises, between the above steps (b) and (c), the step of forming a gate electrode having an opening portion over the electron-emitting-portion-forming layer,

wherein the conical electron emitting portion made of carbon is formed on the electron-emitting-portion-forming layer under the opening portion in the step (c). The above constitution will be referred to as “second constitution A” of the present invention for convenience.

Alternatively, there may be employed a constitution in which the method further comprises, between the above steps (b) and (c), the step of;

forming an insulating layer on the support member and the electron-emitting-portion-forming layer,

forming a gate electrode having an opening portion on the insulating layer, and

forming, in the insulating layer, a second opening portion communicating with the opening portion formed in the gate electrode,

wherein the conical electron emitting portion made of carbon is formed on the electron-emitting-portion-forming layer positioned in the bottom of the second opening portion in the step (c). The above constitution will be referred to as “second constitution B” of the present invention for convenience.

Alternatively, in the production method according to the second aspect of the present invention, there may be employed a constitution in which the method comprises, between the steps (a) and (b), the steps of;

forming an insulating layer on the support member and the cathode electrode,

forming a gate electrode having an opening portion on the insulating layer, and

forming, in the insulating layer, a second opening portion communicating with the opening portion formed in the gate electrode,

wherein the electron-emitting-portion-forming layer is formed on the cathode electrode positioned in the bottom of the second opening portion in the step (b). The above constitution will be referred to as “second constitution C” of the present invention for convenience.

Alternatively, in the production method according to the second aspect of the present invention, there may be employed a constitution in which the step (c) is followed by the step of forming a gate electrode having an opening portion over the electron emitting portion. The above constitution will be referred to as “second constitution D” of the present invention for convenience.

Alternatively, in the production method according to the second aspect of the present invention, there may be employed a constitution in which the step (c) is followed by the steps of;

forming an insulating layer on the support member and the electron emitting portion,

forming a gate electrode having an opening portion on the insulating layer, and

forming, in the insulating layer, a second opening portion which communicates with the opening portion formed in the gate electrode and in a bottom of which the electron emitting portion is exposed. The above constitution will be referred to as “second constitution E” of the present invention for convenience.

In the production method according to the second aspect of the present invention, from the viewpoints that the dissociation degree of a source gas used for the formation of the electron emitting portion is increased and that the conical electron emitting portion is reliably formed, preferably, the step of forming the conical electron emitting portion made of carbon is carried out on the basis of a plasma CVD method under a condition satisfying a plasma density of at least 10¹⁶m⁻³ (10⁷mm⁻³), preferably at least 10¹⁷m⁻³ (10⁸mm⁻³), more preferably at least 10¹⁹m⁻³ (10¹⁰mm⁻³) in a state where a bias voltage is applied to the support member. Otherwise, from the viewpoints that the dissociation degree of a source gas used for the formation of the electron emitting portion is increased and that the conical electron emitting portion is reliably formed, preferably, the step of forming the conical electron emitting portion made of carbon is carried out on the basis of a plasma CVD method under a condition satisfying an electron temperature of 1 to 15 eV, preferably 5 eV to 15 eV and an ion current density of 0.1 mA/cm² to 30 mA/cm², preferably, 5 mA/cm² to 30 mA/cm², in a state where a bias voltage is applied to the support member. In these cases, for satisfying the above conditions, the plasma CVD method is selected from an inductively coupled plasma CVD method, an electron cyclotron resonance plasma CVD method, a helicon wave plasma CVD method or a capacitively coupled plasma CVD method. In the step of forming the conical electron emitting portion made of carbon, the temperature for heating the support member can be set at 600° C. or lower, preferably at 500° C. or lower, more preferably at 400° C. or lower, still more preferably at 300° C. or lower. The temperature lower limit of heating the support member can be a temperature at which the conical electron emitting portion made of carbon can be formed.

The source gas for use in the plasma CVD method for forming the electron emitting portion includes hydrocarbon gases such as methane (CH₄), ethane (C₂H₆), propane (C₃H₈), butane (C₄H₁₀), ethylene (C₂H₄) and acetylene (C₂H₂), mixtures of these, and a mixture of a hydrocarbon gas with hydrogen gas. Further, the source gas can be also selected from gasified gas of methanol, ethanol, acetone, benzene, toluene or xylene or a gas mixture of such a gas with hydrogen gas. Further, a rare gas such as helium (He) or Argon (Ar) may be introduced for stabilizing discharge and promoting plasma dissociation. When a gas mixture of a hydrocarbon gas with hydrogen gas is used, preferably, the amount of the hydrocarbon gas on the basis of the total flow amount of the hydrocarbon gas and the hydrogen gas is less than 50% by volume.

In the electron-emitting device of the present invention, the cold cathode field emission device or the cold cathode field emission display of the present invention including the first to fourth constitutions and the production method according to the second aspect of the present invention including various constitutions, preferably, the electron-emitting-portion-forming layer is formed of a metal thin layer. The electron-emitting-portion-forming layer can be formed by a physical vapor deposition method or a plating method (including an electric plating method and an electroless plating method). The physical vapor deposition method includes (1) vacuum deposition methods such as an electron beam heating method, a resistance heating method and a flash deposition method, (2) a plasma deposition method, (3) sputtering methods such as a bipolar sputtering method, a DC sputtering method, a DC magnetron sputtering method, a high-frequency sputtering method, a magnetron sputtering method, an ion beam sputtering method and a bias sputtering method, and (4) ion plating methods such as a DC (direct current) method, an RF method, a multi-cathode method, an activating reaction method, an electric field deposition method, a high-frequency ion plating method and a reactive ion-plating method.

Preferably, the above metal thin layer is composed of at least one metal selected from the group consisting of nickel (Ni), molybdenum (Mo), titanium (Ti), chromium (Cr), cobalt (Co), tungsten (W), zirconium (Zr), tantalum (Ta), iron (Fe), copper (Cu), platinum (Pt), zinc (Zn), cadmium (Cd), germanium (Ge), tin (Sn), lead (Pb), bismuth (Bi), silver (Ag), gold (Au), indium (In) and thallium (Tl), or composed of an alloy containing any one of these elements, or composed of an organometal. Further, besides the above metals, there can be used a metal that exhibits catalysis in an atmosphere employed for forming (synthesizing) the electron emitting portion.

In the electron-emitting device of the present invention, the cold cathode field emission device or the cold cathode field emission display of the present invention including the first to fourth constitutions and the production method according to the first or second aspect of the present invention including various constitutions, preferably, the value of H/(S/π)^{1/2} (so-called aspect ratio) is 3 to 7 in which S is an area of bottom surface of the conical electron emitting portion and H is a height thereof.

The conical electron emitting portion generally has the form of a circular cone although the form differs depending upon its forming conditions. Generally, a number of electron emitting portions are formed on the surface of a portion of the cathode electrode or the electron-emitting-portion-forming layer which portion is positioned in the bottom of the opening portion or the second opening portion.

In the cold cathode field emission device or the cold cathode field emission display of the present invention, it is sufficient that the electron-emitting-portion-forming layer should be formed on the surface of the cathode electrode positioned in the bottom of the opening portion or the second opening portion (these will be generically referred to as “opening portion and the like” hereinafter). Further, the electron-emitting-portion-forming layer may be formed so as to cover that portion of the cathode electrode which is positioned in the bottom of the opening portion and the like, and that portion of the cathode electrode which is located somewhere other than the bottom of the opening portion and the like and is covered with the insulating layer. Further, the electron-emitting-portion-forming layer may be formed on the entire surface or part of the surface of that portion of the cathode electrode which is positioned in the bottom of the opening portion and the like.

In the second constitution or the fourth constitution of the present invention, the opening portion formed in the gate electrode (this opening portion will be sometimes referred to as “first opening portion” for convenience) and the second opening portion may have the relationship of one-to-one correspondence (that is, one second opening portion may be formed so as to correspond to one first opening portion). Otherwise, the-first and second opening portions may have the relationship of “many to one” correspondence (that is, one second opening portion may be formed so as to correspond to many first opening portions). The insulating layer may have a constitution in which it works as a kind of stripe-shaped separation wall provided between the cathode electrode and the gate electrode although it depends upon the constitution of the cold cathode field emission device.

In the production method according to the second constitution C of the present invention, the step (b) may comprise the steps of forming a mask layer through which the surface of the cathode electrode is exposed in the central portion of bottom of the second opening portion (that is, forming a mask layer at least on the side wall of the second opening portion) and forming the electron-emitting-portion-forming layer on the mask layer and the exposed surface of the cathode electrode, although it depends upon the method of forming the electron-emitting-portion-forming layer.

The above mask layer can be formed, for example, by a method in which a resist material layer or a hard mask material layer is formed on the entire surface and making a hole in a portion of the resist material layer or the hard mask material layer which portion is positioned in the central portion of the bottom of the second opening portion by lithography. In a state where the mask layer covers part of the cathode electrode which part is positioned in the bottom of the second opening portion, the side wall of the second opening portion, the side wall of the first opening portion and the gate electrode, the electron-emitting-portion-forming layer is formed on the surface of the cathode electrode which surface is positioned in the central portion of the bottom of the second opening portion. Therefore, short-circuiting between the cathode electrode and the gate electrode through the electron-emitting-portion-forming layer or the electron emitting portion can be reliably prevented. In some cases, the mask layer may cover the gate electrode alone. Otherwise, the mask layer may cover only the gate electrode in the vicinity of the first opening portion formed in the gate electrode, or the mask layer may cover the gate electrode in the vicinity of the first opening portion and the side walls of the first and second opening portions. In these cases, an electron emitting portion may be formed on the gate electrode depending upon an electrically conductive material constituting the gate electrode. However, electrons are not emitted from the above electron emitting portion when the above electron emitting portion is not placed in a high-intensity electric field. It is preferred to remove the mask layer before the formation of the electron emitting portion on the electron-emitting-portion-forming layer.

In the production method according to the second constitution B, the second constitution C or the second constitution E of the present invention, the method for forming the gate electrode having the first opening portion on the insulating layer includes a method in which an electrically conductive material layer for a gate electrode is formed on the insulating layer; then, a patterned first mask material layer is formed on the electrically conductive material layer; the electrically conductive material layer is etched with using the first mask material layer as an etching mask, to pattern the electrically conductive material layer; then, the first mask material layer is removed; then, a patterned second mask material layer is formed on the electrically conductive material layer and the insulating layer; and the electrically conductive material layer is etched with using the second mask material layer as an etching mask, to form the first opening portion, and a method in which the gate electrode having the first opening portion is directly formed, for example, by a screen printing method. In these cases, the method for forming, in the insulating layer, the second opening portion communicating with the first opening portion formed in the gate electrode may be a method in which the insulating layer is etched with using the above second mask material layer as an etching mask, or may be a method in which the insulating layer is etched with using, as an etching mask, the first opening portion formed in the gate electrode. The first opening portion and the second opening portion may have the relationship of one-to-one correspondence (that is, one second opening portion may be formed so as to correspond to one first opening portion). The first and second opening portions may have the relationship of “many to one” correspondence (that is, one second opening portion may be formed so as to correspond to many first opening portions). Further, the step of forming the gate electrode having an opening portion may comprise the step of preparing, for the gate electrode, a stripe-shaped material layer having a plurality of opening portions and fixing the stripe-shaped material layer on the insulating layer. The second opening portion can be formed by isotropic etching (more specifically, isotropic etching of that portion of the insulating layer which constitutes the side wall of the second opening portion), dry etching using a radical as main etching species such as chemical dry etching, or wet etching using an etching solution.

In the production method according to the second constitution A or the second constitution D of the present invention, the step of forming the gate electrode may be the step of forming a stripe-shaped separation wall made of an insulating material on the support member, preparing, for the gate electrode, a stripe-shaped material layer having a plurality of opening portions and fixing the stripe-shaped material layer so as to bring the stripe-shaped material layer into contact with the top surface of the separation wall.

For more reliable selective growth of the electron emitting portion on the cathode electrode or the electron-emitting-portion-forming layer, it is desirable to remove an oxide (so-called natural oxide layer) on the surface of the cathode electrode or the electron-emitting-portion-forming layer. Preferably, the oxide is removed, for example, by a plasma reduction treatment according to a microwave plasma method in a hydrogen gas atmosphere, a trans-form plasma method in a hydrogen gas atmosphere, an inductively coupled plasma method in a hydrogen gas atmosphere, an electron cyclotron resonance plasma method in a hydrogen gas atmosphere or an RF plasma method in a hydrogen gas atmosphere, a sputtering treatment in an argon gas atmosphere or a washing treatment using an acid such as hydrofluoric acid or a base. When the electron-emitting device of the present invention is produced, the above various steps may be as well applied to the surface of a portion of the electrically conductive layer on which portion the electron emitting portion is to be formed.

In the cold cathode field emission device and the cold cathode field emission display of the present invention and the production methods according the first and second aspects of the present invention (these will be sometimes generically referred to as “the cold cathode field emission device and the like or the production method of the present invention” hereinafter), when no gate electrode is provided, generally, the cathode electrode may have the outer form of a rectangle or a stripe. When a gate electrode is provided, preferably, the gate electrode has an outer form of a stripe, and the cathode electrode also has an outer form of a stripe. The cathode electrode in the form of a stripe extends in one direction, and the gate electrode in the form of a stripe extends in another direction. Preferably, a projection image of the cathode electrode in the form of a stripe and a projection image of the gate electrode in the form of a stripe cross each other at right angles. In a region where these two projection images of the electrodes overlap (the region corresponding to one pixel and being a region where the cathode electrode and the gate electrode overlap), one electron-emitting-portion-forming layer or a plurality of electron-emitting-portion-forming layers are positioned. Further, such overlapped regions are arranged, generally, in the form of a two-dimensional matrix in the effective field of the cathode panel (field that works as an actual display screen). The arrangement of the cold cathode field emission devices in each pixel may be regular or may be at random. In the cold cathode field emission device, generally, the position of the electron emitting portion on the cathode electrode or on the electron-emitting-portion-forming layer is at random.

In the cold cathode field emission device and the like or the production method of the present invention, each of the first opening portion and the second opening portion may have any plan form (form obtained by cutting these opening portions with an imaginary plane in parallel with the cathode electrode) such as the form of a circle, an oval, a rectangle, a polygon, a roundish rectangle, a roundish polygon, or the like.

In the cold cathode field emission device and the like or the production method of the present invention, the cathode electrode may have any structure such as a single layer structure of an electrically conductive material layer or a three-layered structure having a lower electrically conductive material layer, a resistance layer formed on the lower electrically conductive material layer and an upper electrically conductive material layer formed on the resistance layer. In the latter case, the electron emitting portion or the electron-emitting-portion-forming layer is formed on a surface of the upper electrically conductive material layer. When the electron-emitting-portion-forming layer is provided, the cathode electrode may have a two-layered structure having a lower electrically conductive material layer and a resistance layer formed on the lower electrically conductive material layer. The above-formed resistance layer works to attain uniform electron emission properties of the electron emitting portions.

In the cold cathode field emission device and the like or the production method of the present invention, there may be employed a constitution in which a second insulating layer is further formed on the gate electrode and the insulating layer and a focus electrode is formed on the second insulating layer. The above focus electrode is provided for converging the pass of electrons which are emitted through the opening portion and attracted toward the anode electrode so that the brightness can be improved and that an optical crosstalk among neighboring pixels can be prevented. The focus electrode is effective particularly for a so-called high-voltage type display in which the anode electrode and the cathode electrode have a potential difference on the order of several kilovolts and have a relatively large distance from one to the other. A relatively negative voltage is applied to the focus electrode from a focus power source. It is not necessarily required to provide the focus electrode per cold cathode field emission device. For example, the focus electrode may be extended in a predetermined direction in which the cold cathode field emission devices are arranged, so that a common focusing effect can be exerted on a plurality of the cold cathode field emission devices.

In the method for the production of a cold cathode field emission display according to the first or second aspect of the present invention, the bonding of the substrate and the support member in their circumferential portions may be carried out with an adhesive layer or with a frame made of an insulating rigid material such as glass or ceramic and an adhesive layer. When the frame and the adhesive layer are used in combination, the facing distance between the substrate and the support member can be adjusted to be longer by properly determining the height of the frame than that obtained when the adhesive layer alone is used. While a frit glass is generally used as a material for the adhesive layer, a so-called low-melting-point metal material having a melting point of approximately 120 to 400° C. may be used. The low-melting-point metal material includes In (indium; melting point 157° C.); an indium-gold low-melting-point alloy; tin (Sn)-containing high-temperature solders such as Sn₈₀Aq₂₀ (melting point 220 to 370° C.) and Sn₉₅Cu₅ (melting point 227 to 370° C.); lead (Pb)-containing high-temperature solders such as Pb_{97.5}Ag_{2.5} (melting point 304° C.), Pb_{94.5}Ag_{5.5} (melting point 304 to 365° C.) and Pb_{97.5}Ag_{1.5}Sn_{1.0} (melting point 309° C.); zinc (zn)-containing high-temperature solders such as Zn₉₅Al₅ (melting point 380° C.); tin-lead-containing standard solders such as Sn₅PB₉₅ (melting point 300 to 314° C.) and Sn₂PB₉₈ (melting point 316 to 322° C.); and brazing materials such as Au₈₈Ga₁₂ (melting point 381° C.) (all of the above parenthesized values show atomic %).

When three members of the substrate, the support member and the frame are bonded, these three members may be bonded at the same time, or one of the substrate and the support member may be bonded to the frame at a first stage and then the other of the substrate and the support member may be bonded to the frame at a second stage. When bonding of the three members or bonding at the second stage is carried out in a high-vacuum atmosphere, a space surrounded by the substrate, the support member, the frame and the adhesive layer comes to be a vacuum space upon bonding. Otherwise, after the three members are bonded, the space surrounded by the substrate, the support member, the frame and the adhesive layer may be vacuumed to obtain a vacuum space. When the vacuuming is carried out after the bonding, the pressure in an atmosphere during the bonding may be any one of atmospheric pressure and reduced pressure, and the gas constituting the atmosphere may be ambient atmosphere or an inert gas containing nitrogen gas or a gas (for example, Ar gas) coming under the group 0 of the periodic table.

When the vacuuming is carried out after the bonding, the vacuuming can be carried out through a tip tube pre-connected to the substrate and/or the support member. Typically, the tip tube is formed of a glass tube and is bonded to a circumference of a through hole formed in an ineffective field of the substrate and/or the support member (i.e., a field other than the effective field which works as a display screen) with a frit glass or the above low-melting-point metal material. After the space reaches a predetermined vacuum degree, the tip tube is sealed by thermal fusion. It is preferred to heat and then temperature-decrease the display as a whole before the sealing, since residual gas can be released into the space, and the residual gas can be removed out of the space by vacuuming.

In the cold cathode field emission device and the like or the production method of the present invention, the support member may be any substrate so long as its surface is composed of an insulating material. The support member includes a glass substrate, a glass substrate having a surface composed of an insulation layer, a quartz substrate, a quartz substrate having a surface composed of an insulation layer and a semiconductor substrate having a surface composed of an insulation layer. The substrate can have the same constitution as that of the support member. In the cold cathode field emission device of the present invention, it is required to form an electrically conductive layer on the support member, and the support member can be composed of an insulating material.

When the electron emitting portion is formed on the electrically conductive layer or the cathode electrode, the electrically conductive layer or the cathode electrode is made of at least one metal selected from the group consisting of nickel (Ni), molybdenum (Mo), titanium (Ti), chromium (Cr), cobalt (Co), tungsten (W), zirconium (Zr), tantalum (Ta), iron (Fe), copper (Cu), platinum (Pt), zinc (Zn), cadmium (Cd), germanium (Ge), tin (Sn), lead (Pb), bismuth (Bi), silver (Ag), gold (Au), indium (In) and thallium (Tl). Further, an alloy containing one or more members of the above elements may be used. Further, besides the above metals, there may be used a metal that behaves as a catalyst in an atmosphere employed for the formation (synthesis) of the electron emitting portion.

When the electron-emitting-portion-forming layer is formed on the electrically conductive layer or the cathode electrode for forming the electron emitting portion on the electron-emitting-portion-forming layer, the electrically conductive layer or the cathode electrode is made from the following material. Further, when the gate electrode or the focus electrode is formed, the gate electrode or the focus electrode is made from the following material. That is, the above materials include metals such as tungsten (W), niobium (Nb), tantalum (Ta), molybdenum (Mo), chromium (Cr), aluminum (Al) and copper (Cu); alloys or compounds containing these metals (for example, nitrides such as TiN and suicides such as WSi₂, MoSi₂, TiSi₂ and TaSi₂); semiconductors such as silicon (Si); and ITO (indium-tin oxide). The materials for the above electrodes may be the same or different. The above electrodes can be formed by a general thin-film-forming method such as a deposition method, a sputtering method, a CVD method, an ion plating method, a screen-printing method or a plating method. In view of preventing the formation of the electron emitting portion on the gate electrode or the focus electrode, preferably, the material constituting the gate electrode or the focus electrode and the material constituting the electron-emitting-portion-forming layer are different from each other. Alternatively, in view of preventing the formation of the electron emitting portion on the gate electrode or the focus electrode, a polysilicon layer or an insulating layer may be formed on the gate electrode or the focus electrode.

The material constituting the insulating layer or the second insulating layer includes SiO₂, SiN, SiON and a glass paste cured product, and these materials may be used alone or in combination. The insulating layer or the second insulating layer can be formed by a known method such as a CVD method, an application method, a sputtering method or a screen-printing method.

The material for the anode electrode can be selected depending upon the constitution of the cold cathode field emission display. When the cold cathode field emission display is a transmission type (the anode panel corresponds to a display portion) and when the anode electrode and the phosphor layer are stacked on the substrate in this order, not only the substrate on which the anode electrode is formed but also the anode electrode itself are required to be transparent, and a transparent electrically conductive material such as ITO (indium-tin oxide) is used. When the cold cathode field emission display is a reflection type (the cathode panel corresponds to a display portion), or when the cold cathode field emission is a transmission type but when the phosphor layer and the anode electrode are stacked on the substrate in this order (the anode electrode works as a metal back film as well), not only ITO can be used, but also the material can be selected from those materials which are discussed with regard to the cathode electrode, the gate electrode and the focus electrode.

The fluorescent material for the phosphor layer can be selected from a fast-electron-excitation type fluorescent material or a slow-electron-excitation type fluorescent material. When the cold cathode field emission display is a monochrome display, it is not required to pattern the phosphor layer. When the cold cathode field emission display is a color display, preferably, the phosphor layers corresponding to three primary colors of red (R), green (G) and blue (B) patterned in the form of stripes or dots are alternately arranged. A black matrix may be filled in a gap between one patterned phosphor layer and another phosphor layer for improving a display screen in contrast.

Examples of the constitution of the anode electrode and the phosphor layer include (1) a constitution in which the anode electrode is formed on the substrate and the phosphor layer is formed on the anode electrode and (2) a constitution in which the phosphor layer is formed on the substrate and the anode electrode is formed on the phosphor layer. In the above constitution (1), a so-called metal back film electrically connected to the anode electrode may be formed on the phosphor layer. In the above constitution (2), the metal back film may be formed on the anode electrode.

The anode electrode may be formed to have a structure in which the effective filed is covered with an electrically conductive material in the form of one sheet or a structure in which anode electrode units each of which corresponds to one or a plurality of electron emitting portions or one or a plurality of pixels are formed together.

When no gate electrode is provided in the cold cathode field emission display of the present invention, the voltage to be applied to the cathode electrode is controlled pixel by pixel. In this case, the anode electrode may be formed to have a structure in which the effective filed is covered with an electrically conductive material in the form of one sheet or a structure in which anode electrode units each of which corresponds to one or a plurality of electron emitting portions or one or a plurality of pixels are formed together. When a voltage greater than the threshold voltage is applied to the cathode electrode, electrons are emitted from the electron emitting portion on the basis of a quantum tunnel effect under an electric field formed by the anode electrode, and the electrons are attracted toward the anode electrode to collide with the phosphor layer. The brightness is controlled by a voltage applied to the cathode electrode. Alternatively, there may be employed a constitution in which the cathode electrode is designed in the form of a stripe, the anode electrode is also designed in the form of a stripe, and the stripe-shaped cathode electrode and the stripe-shaped anode electrode are arranged such that the projection image of the cathode electrode and the projection image of the anode electrode cross each other at right angles. Electrons are emitted from the electron emitting portion positioned in an overlapped region of the projection image of the anode electrode and the projection image of the cathode electrode. A display having such a constitution is driven by a so-called simple matrix method. That is, a relatively negative voltage is applied to the cathode electrode, and a relatively positive voltage is applied to the anode electrode. As a result, electrons are emitted into the vacuum space selectively from the electron emitting portion in an anode electrode/cathode electrode overlapped region of a selected column of the cathode electrode and a selected row of the anode electrode (or a selected row of the cathode electrode and a selected column of the anode electrode), and the electrons are attracted toward the anode electrode and collide with the phosphor layer constituting the anode panel to excite the phosphor layer to emit light.

In the cold cathode field emission display having the gate electrode, operation is conducted by a so-called simple matrix method. That is, a relatively negative voltage is applied to the cathode electrode from a cathode electrode control circuit, a relatively positive voltage is applied to the gate electrode from a gate electrode control circuit, and a positive voltage far higher than the voltage to be applied to the gate electrode is applied to the anode electrode from an anode electrode control circuit. When the above cold cathode field emission display is used for display, for example, a scanning signal is inputted to the cathode electrode from the cathode electrode control circuit, and a video signal is inputted to the gate electrode from the gate electrode control circuit. The brightness is controlled by the voltage to be inputted to the gate electrode.

In the present invention, the conical electron emitting portion made of carbon is provided, so that electrons can be emitted under a far lower electric field. Further, the electron emitting portion can be selectively formed on the electrically conductive layer, the cathode electrode or the electron-emitting-portion-forming layer, and a kind of catalytic reaction can be expected on the electrically conductive layer, the cathode electrode or the electron-emitting-portion-forming layer, so that the temperature for forming the electron emitting portion can be decreased. Moreover, a treatment, such as patterning, for shaping the electron emitting portion in a desired form is no longer necessary. Further, the conical electron emitting portion made of carbon is provided, so that a cold cathode field emission device having high electron emission efficiency can be obtained, and that a cold cathode field emission display that attains low power consumption and high-quality screen images can be obtained.

### BRIEF DESCRIPTION OF DRAWINGS

The present invention will be explained on the basis of Examples with reference to drawings hereinafter.

FIG. 1 is a schematic partial cross-sectional view of a cold cathode field emission display in Example 1.

FIG. 2 is a schematic perspective view of a cathode electrode and electron emitting portions in a cold cathode field emission device in Example 1.

FIGS. 3A, 3B and 3C are schematic partial end views of a support member, etc., for explaining a method of producing the cold cathode field emission device in Example 1.

FIGS. 4A, 4B, 4C and 4D are schematic partial cross-sectional views of a substrate, etc., for explaining a method of producing an anode panel AP.

FIG. 5 is a graph showing results of measurements of electric fields exerted on an electron emitting portion and currents of emitted electrons in the cold cathode field emission display in Example 1.

FIGS. 6A, 6B and 6C are schematic partial cross-sectional views of a support member, etc., for explaining a cold cathode field emission device in Example 2.

FIG. 7 is a schematic partial plan view showing a layout of gate electrodes, separation walls and cathode electrodes in the cold cathode field emission devices in Example 2.

FIG. 8 is a schematic partial cross-sectional view of a support member, etc., for explaining how to fix a gate electrode in a variant of the cold cathode field emission device in Example 2.

FIG. 9 is a schematic partial end view of a cold cathode field emission display in Example 2.

FIGS. 10A, 10B, 10C and 10D are schematic partial plan views of plurality of opening portions of the gate electrode in Example 2.

FIGS. 11A, 11B and 11C are schematic partial end views of a support member, etc., for explaining a method of producing a cold cathode field emission device in Example 3.

FIG. 12, following FIG. 1C, is a schematic partial end view of the support member, etc., for explaining the method of producing the cold cathode field emission device in Example 3.

FIG. 13 is a schematic partial end view of the cold cathode field emission display in Example 3.

FIG. 14 is a schematic exploded perspective view of the cold cathode field emission display in Example 3.

FIGS. 15A, 15B and 15C are schematic partial end views of a support member, etc., for explaining a method of producing a cold cathode field emission device in Example 4.

FIGS. 16A, 16B, 16C and 16D are schematic partial cross-sectional views of a support member, etc., for explaining a method of producing a cold cathode field emission device in Example 5.

FIGS. 17A and 17B are a schematic partial cross-sectional view and a schematic partial end view of cold cathode field emission devices in Examples 6 and 7, respectively.

FIGS. 18A, 18B and 18C are schematic partial end views of a support member, etc., for explaining a method of producing a cold cathode field emission device in Example 9.

FIGS. 19A and 19B are schematic partial end views of a support member, etc., for explaining a method of producing a cold cathode field emission device in Example 10.

FIG. 20 is a schematic partial end view of a cold cathode field emission device having a focus electrode.

FIG. 21 is a schematic drawing showing a constitution example of a conventional cold cathode field emission display having Spindt type cold cathode field emission devices.

FIGS. 22A, 22B and 22C are schematic partial end views of a support member, etc., for explaining a method of producing a conventional Spindt type cold cathode field emission device.

FIGS. 23A and 23B, following FIG. 22C, are schematic partial end views of the support member, etc., for explaining the method of producing the conventional Spindt type cold cathode field emission device.

### DESCRIPTION OF THE PREFERRED EMBODIMENTS

### Example 1

Example 1 is concerned with the electron-emitting device of the present invention, the cold cathode field emission device (to be abbreviated as “field emission device” hereinafter) according to the first constitution and the cold cathode field emission display (to be abbreviated as “display” hereinafter) according to the first constitution. It also concerned with the production method according to the first aspect of the present invention.

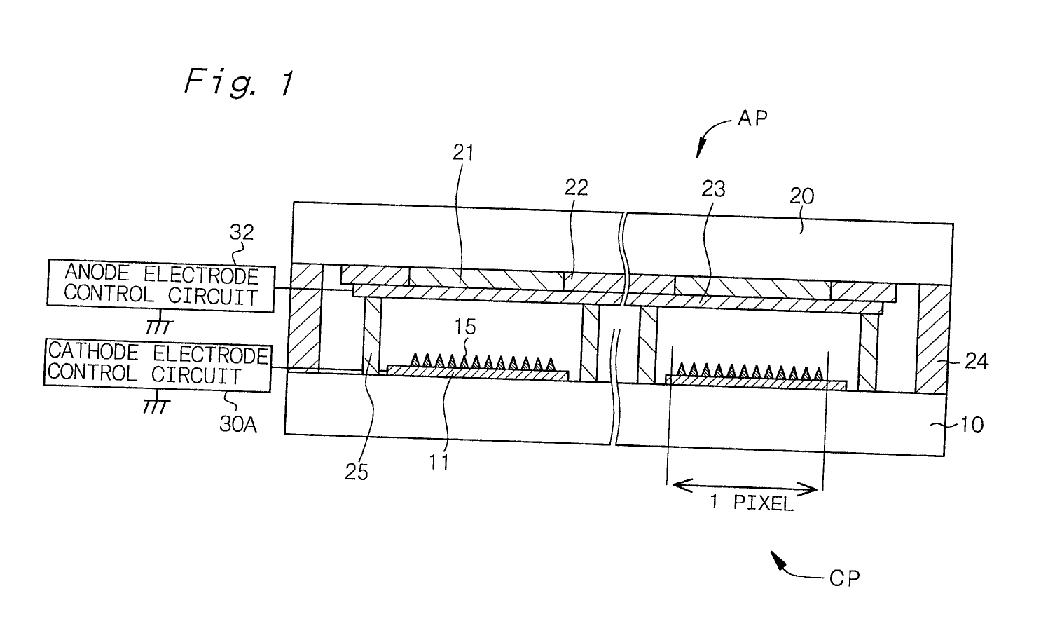

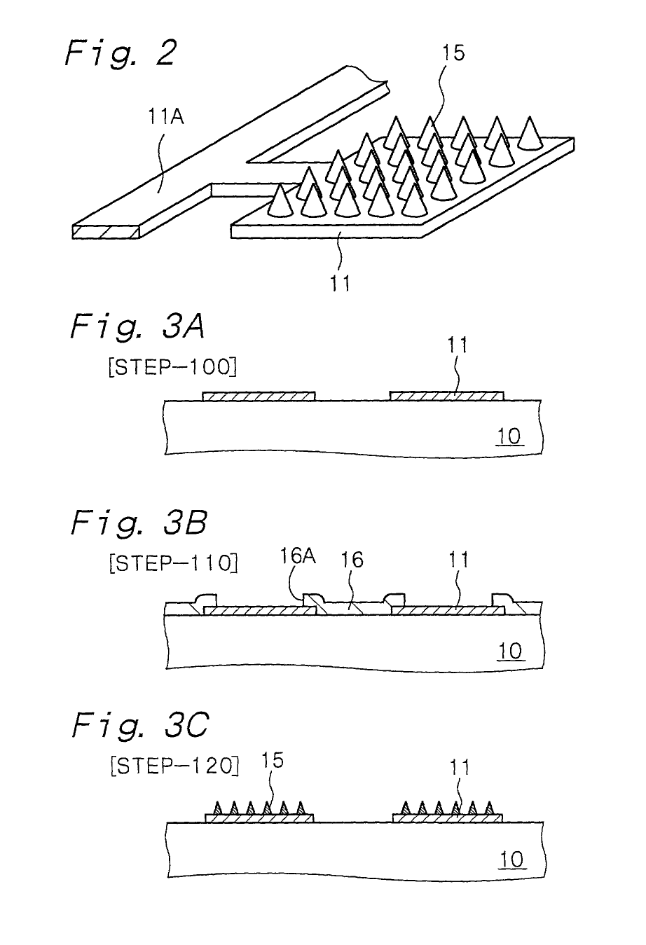

FIG. 1 shows a schematic partial cross-sectional view of a display in Example 1, FIG. 2 shows a schematic perspective view of one electron emitting portion, and FIG. 3C shows a schematic partial end view of a field emission device. The electron-emitting device in Example 1 has a conical electron emitting portion 15 made of carbon and formed on the electrically conductive layer (specifically, cathode electrode 11). The field emission device in Example 1 comprises a cathode electrode 11 formed on a support member 10, and a conical electron emitting portion 15 made of carbon and formed on the cathode electrode 11. The electron emitting portion 15 is selectively formed on the electrically conductive layer (specifically, cathode electrode 11).

The display in Example 1 comprises a cathode panel CP having a number of the above field emission devices formed on the effective field thereof and an anode panel AP, and it is also constituted of a plurality of pixels. Each pixel is constituted of the field emission devices, an anode electrode 23 and a phosphor layer 21. The anode electrode 23 and the phosphor layer 21 are formed on a substrate (anode panel AP) so as to face the field emission devices. The cathode panel CP and the anode panel AP are bonded to each other through a frame 24 in their circumferential portions. The field emission device has a basic constitution as shown in FIG. 3C. Further, a through hole for vacuuming (not shown) is formed in the ineffective field of the cathode panel CP, and a tip tube (not shown) is connected to the through hole. The tip tube is sealed after vacuuming. The frame 24 is made of ceramic or glass, and has a height, for example, of 1.0 mm. In some cases, an adhesive layer alone may be used in place of the frame 24.

The anode panel AP comprises a substrate 20, a phosphor layer 21 formed on the substrate 20 and formed in a predetermined pattern and an anode electrode 23 composed, for example, of an aluminum thin film covering the entire surface. A black matrix 22 is formed on the substrate 20 between one phosphor layer 21 and another phosphor layer 21. The black matrix 22 may be omitted. When it is intended to produce a monochrome display, the phosphor layer 21 is not required to be in a predetermined pattern. Further, an anode electrode composed of a transparent electrically conductive film of ITO or the like may be formed between the substrate 20 and the phosphor layer 21. Otherwise, the anode panel AP may be constituted of the anode electrode 23 composed of a transparent electrically conductive film provided on the substrate 20, the phosphor layer 21 and the black matrix 22 both formed on the anode electrode 23, and a light reflection electrically conductive film which is made of aluminum, is formed on the phosphor layer 21 and the black matrix 22 and is electrically connected to the anode electrode 23.

Each pixel is constituted of the cathode electrode 11 having a rectangular form on the cathode panel side, a plurality of the field emission devices 15 formed thereon and the phosphor layer 21 arranged in the effective field of the anode panel AP so as to face the field emission devices. In the effective field, such pixels are arranged on the order, for example, of hundreds of thousands to several millions.

Further, spacers 25 as auxiliary means are disposed between the cathode panel CP and the anode panel AP for maintaining a constant distance between these two panels, and the spacers 25 are disposed in regular intervals in the effective field. The form of the spacers 25 is not limited to a columnar form, and the spacers 25 may have a spherical form or may be ribs in the form of a stripe. It is not required to arrange the spacers 25 in four corners of each overlapped region of the anode electrode and the cathode electrode. The spacers 25 may be more sparsely arranged, or the arrangement thereof may be irregular.

In the above display, the voltage to be applied to the cathode electrode 11 is controlled in the unit of one pixel. When viewed as a plan view, the cathode electrode 11 has a nearly rectangular form, and each cathode electrode 11 is connected to a cathode electrode control circuit 30A through a wiring 11A and a switching element (not shown) formed, for example, of a transistor. Further, the anode electrode 23 is connected to an anode electrode control circuit 32. When a voltage higher than a threshold voltage is applied to each cathode electrode 11, electrons are emitted from the electron emitting portion 15 on the basis of a quantum tunnel effect due to an electric field generated by the anode electrode 23, and the electrons are attracted toward the anode electrode 23 and collide with the phosphor layer 21. The brightness is controlled on the basis of a voltage applied to the cathode electrode 11. In the electron-emitting device, the field emission device or the display in Example 1, the top end of the electron emitting portion is directed toward the anode electrode 23 and sharpened, so that they are excellent in current efficiency, that is, a ratio of an anode current value to a cathode current value.

The method of producing the field emission device and the method for producing the display in Example 1, which are the production method according to the first aspect of the present invention, will be explained with reference to FIGS. 3A to 3C. In Example 1, the field emission device is produced by the steps of;

forming the cathode electrode 11 on the support member 11, and

selectively forming the electron emitting portion 15 made of carbon on the surface of the cathode electrode 11.

In Example 1, nickel (Ni) was used as a material for constituting the electrically conductive layer or the cathode electrode 11.

[Step-100]

First, an electrically conductive layer is formed on the support member 10 made, for example, of a glass substrate, and then the electrically conductive layer is patterned by lithography and a reactive ion etching method (RIE method), to form the cathode electrode 11 having a nearly rectangular form and the wiring 11A (not shown) on the support member 10 (see FIG. 3A). The electrically conductive layer is, for example, an approximately 0.2 μm thick nickel (Ni) layer formed by a sputtering method. Table 1 shows a condition of forming the nickel layer by a sputtering method, and Table 2 shows a condition of etching the nickel layer.

TABLE 1
Condition of forming nickel layer

| | |
|---|---|
| Target | Ni |
| Ar flow rate | 100 SCCM |
| Pressure | 0.5 Pa |
| DC power | 2 kw |
| Sputtering temperature | 200° C. |

TABLE 2
Condition of etching nickel layer

| | |
|---|---|
| Etching system | Parallel plate RIE system |
| Cl₂ flow rate | 100 SCCM |
| Pressure | 0.7 Pa |
| RF power | 0.8 kW (13.56 MHz) |
| Etching temperature | 60° C. |

[Step-110]

Then, a mask layer 16 made of a resist material is formed on the entire surface, and a hole portion 16A is formed in the mask layer 16 by photolithography (see FIG. 3B). The hole portion 16A is positioned in the central portion of the rectangular cathode electrode 11.

[Step-120]

Then, the conical electron emitting portions 15 made of carbon are formed on the exposed cathode electrode 11 under a condition shown in Table 3 by a helicon wave plasma CVD method using a helicon plasma CVD apparatus. No electron emitting portions are formed on the mask layer 16. Then, the mask layer 16 is removed, to give the electron emitting portions 15 structured as shown in FIG. 3C.

TABLE 3

| | |
|---|---|
| Source gas | methane gas/hydrogen |
| | gas = 30/70 sccm |
| Electric source power | 500 W |
| Support member bias | 50 W (70 volts) |
| power | |
| Reaction pressure | 0.1 Pa |
| Support member heating | 400° C. |
| temperature | |
| Plasma density | 1 × 10¹⁸m⁻³ |
| Electron temperature | 8 eV |
| Ion current density | 10 mA/cm² |

The conical electron emitting portions 15 can be formed even at a lower temperature (for example, 100° C.) depending upon a plasma CVD condition (particularly, bias voltage to the support member 10, plasma density, electron temperature and ion current density) and the surface condition of the cathode electrode 11 that is a substratum. The synthesis condition may be changed as required for varying crystallinity of carbon constituting the electron emitting portions. Further, for improving electron emission properties, a natural oxide layer on the surface of the cathode electrode 11 may be removed, for example, by a plasma reducing treatment using hydrogen (H₂) or ammonia (NH₃), a sputtering treatment in an argon (Ar) or helium (He) atmosphere or a washing treatment using an acid such as hydrofluoric acid or a base, before the formation of the electron emitting portions 15. This is also applicable to various methods to be explained hereinafter.

[Step-130]

Then, the display is assembled. Specifically, for example, after the spacer 25 is disposed on the cathode panel CP, the anode panel AP and the cathode panel CP are arranged such that the anode electrode 23 and the field emission devices face each other, and the anode panel AP and the cathode panel CP (more specifically, the substrate 20 and the support member 10) are bonded to each other in their circumferential portions through the frame 24. In the above bonding, a frit glass is applied to bonding portions of the frame 24 and the anode panel AP and bonding portions of the frame 24 and the cathode panel CP. Then, the anode panel AP, the cathode panel CP and the frame 24 are attached. The frit glass is pre-calcined or pre-sintered to be dried, and then fully calcined or sintered at approximately 450° C. for 10 to 30 minutes. Then, a space surrounded by the anode panel AP, the cathode panel CP, the frame 24 and a bonding layer (not shown) is vacuumed through a through hole (not shown) and a tip tube (not shown), and when the space comes to have a pressure of approximately 10⁻⁴ Pa, the tip tube is sealed by thermal fusion. In the above manner, the space surrounded by the anode panel AP, the cathode panel CP and the frame 24 can be vacuumed. Then, wiring to external circuits is carried out to complete the display.

In the display having the above constitution, the electron emitting portions of the field emission device are made of cones-shaped carbon that is formed on the cathode electrode 11 and has a low work function, and processing thereof does not require any complicated or advanced processing techniques that are required for a conventional Spindt type field emission device. Moreover, no etching of the carbon is required. When the effective field of the display is therefore increased and when the number of the electron emitting portions formed is greatly increased, the electron emission efficiency can be made uniform on the entire region of the effective field, and there can be realized a display that attains high-quality images in which no or little brightness non-uniformity takes place. When the electron emitting portions 15 were observed for their shapes through a scanning electron microscope, the top end thereof had a radius of curvature of approximately 14 nm, the aspect ratio (H/R) of the height H of the electron emitting portions to the diameters R of the bottoms thereof was 3 to 7, and the bottoms of the electron emitting portions had a diameter R of 72 nm on average.

In the thus-obtained display, an accelerating voltage was applied to the anode electrode 23 to determine an electric field E (unit: V/μm) applied to the electron emitting portions 15 by calculation, and 0 volt was applied to the cathode electrode 11 to measure an emitted-electron current I (unit:×10⁻⁴A/μm). FIG. 5 shows the results. As shown in FIG. 5, when the electric field E was 4 V/μm, a sufficient emitted-electron current I was obtained. Concerning a general Spindt type field emission device, it is said that an electric field of 10³ V/μm is required for obtaining an emitted-electron current I to such an extent.

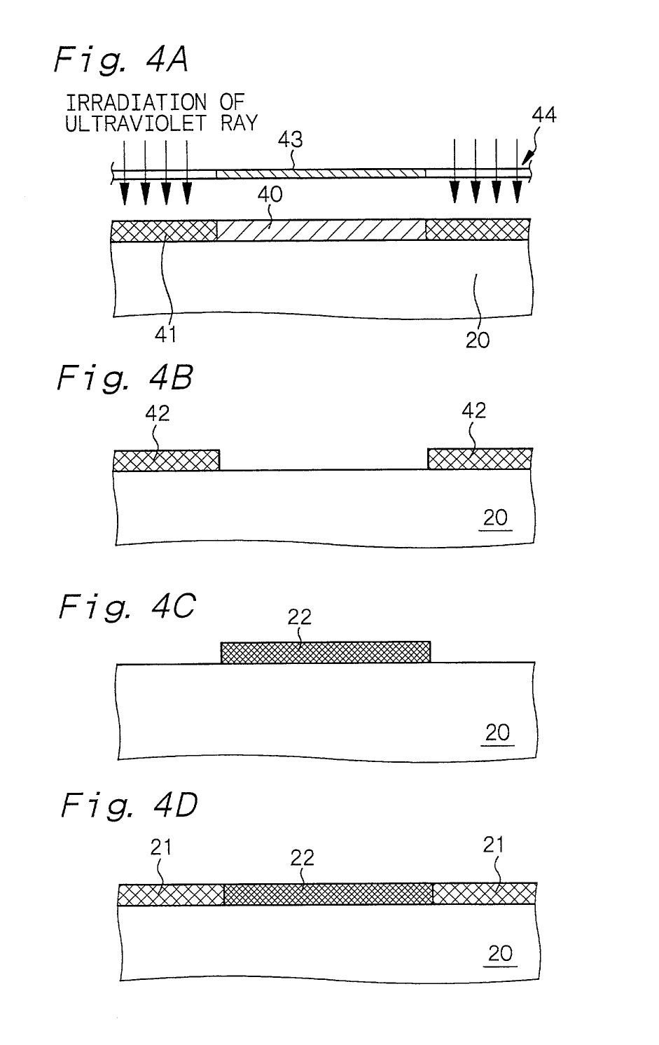

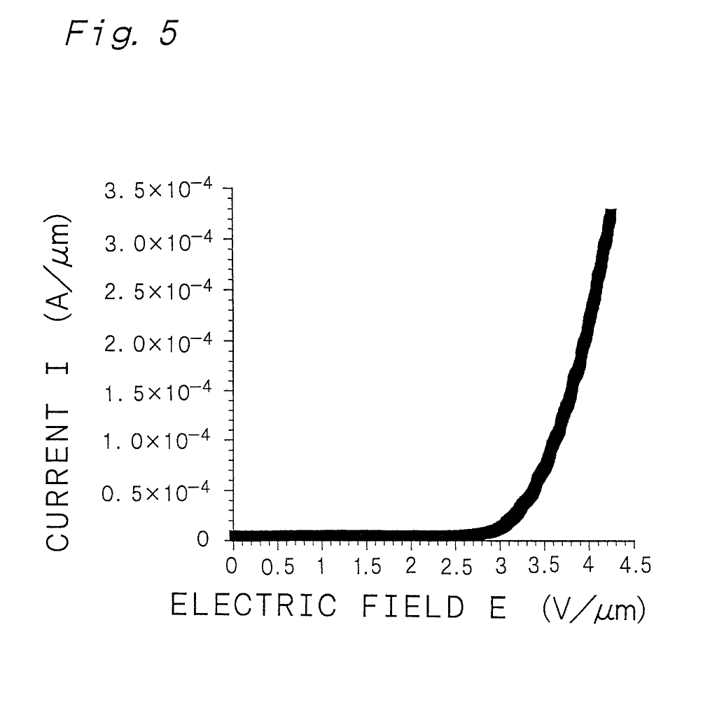

One example of method of preparing the anode panel AP in the display shown in FIG. 1 will be explained with reference to FIGS. 4A to 4D. First, a light-emitting crystal particle composition is prepared. For this purpose, for example, a dispersing agent is dispersed in pure water, and the mixture is stirred with a homo-mixer at 3000 rpm for 1 minute. Then, the light-emitting crystal particles are poured into the dispersion of the dispersing agent and pure water, and the mixture is stirred with a homo-mixer at 5000 rpm for 5 minutes. Then, for example, polyvinyl alcohol and ammonium bichromate are added, and the resultant mixture is fully stirred and filtered.

In the preparation of the anode panel AP, a photosensitive coating 40 is formed (applied) on the entire surface of a substrate 20 made, for example, of glass. Then, the photosensitive coating 40 formed on the substrate 20 is exposed to light which is radiated from a light source (not shown) and passes through openings 44 formed in a mask 43, to form a light-exposed region 41 (see FIG. 4A). Then, the photosensitive coating 40 is selectively removed by development, to retain a remaining photosensitive coating portion (exposed and developed photosensitive coating) 42 on the substrate 20 (see FIG. 4B). Then, a carbon agent (carbon slurry) is applied to the entire surface, dried and calcined or sintered, and then, the remaining photosensitive coating portion 42 and the carbon agent thereon are removed by a lift-off method, whereby a black matrix 22 made of the carbon agent is formed on the exposed substrate 20, and at the same time, the remaining photosensitive coating portion 42 is removed (see FIG. 4C). Then, phosphor layers 21 of red, green and blue are formed on the exposed substrate 20 (see FIG. 4D). Specifically, the light-emitting crystal particle compositions prepared from the light-emitting crystal particles (fluorescent particles) are used. For example, a red photosensitive light-emitting crystal particle composition (fluorescent slurry) is applied to the entire surface, followed by exposure to light and development. Then, a green photosensitive light-emitting crystal particle composition (fluorescent slurry) is applied to the entire surface, followed by exposure to light and development. Further, a blue photosensitive light-emitting crystal particle composition (fluorescent slurry) is applied to the entire surface, followed by exposure to light and development. Then, the anode electrode 23 made of an approximately 0.07 μm thick aluminum thin film is formed on the phosphor layers 21 and the black matrix 22 by a sputtering method. Alternatively, each phosphor layer 21 can be also formed by a screen-printing method or the like.

Each pixel may be constituted of the cathode electrode in the form of a stripe, the electron emitting portion formed thereon and the phosphor layer arranged in the effective field of the anode panel so as to face the electron emitting portion. In this case, the anode electrode also has the form of a stripe. The projection image of the stripe-shaped cathode electrode and the projection image of the stripe-shaped anode electrode cross each other at right angles. Electrons are emitted from the electron emitting portion positioned in the overlapped region of the projection image of the anode electrode and the projection image of the cathode electrode. The thus-constituted display is driven by a so-called simple matrix method. That is, a relatively negative voltage is applied to the cathode electrode, and a relatively positive voltage is applied to the anode electrode. As a result, electrons are emitted into the vacuum space selectively from the electron emitting portion in an anode electrode/cathode electrode overlapped region of a selected column of the cathode electrode and a selected row of the anode electrode (or a selected row of the cathode electrode and a selected column of the anode electrode), and the electrons are attracted toward the anode electrode and collide with the phosphor layer constituting the anode panel to excite the phosphor layer to emit light.

For producing the field emission device having the above structure, not the cathode electrode having the form of a rectangle but the stripe-shaped cathode electrode 11 can be formed on the support member 10 as follows. In

[Step-100], an electrically conductive layer made of nickel (Ni) for forming the cathode electrode is formed on the support member 10 made, for example, of a glass substrate, for example, by a sputtering method, and then the electrically conductive layer is patterned by known lithography and a known RIE method.

### EXAMPLE 2

Example 2 is concerned with the field emission device according to the first constitution and the display according to the first constitution, and it is also concerned with the production method according to the first constitution A.

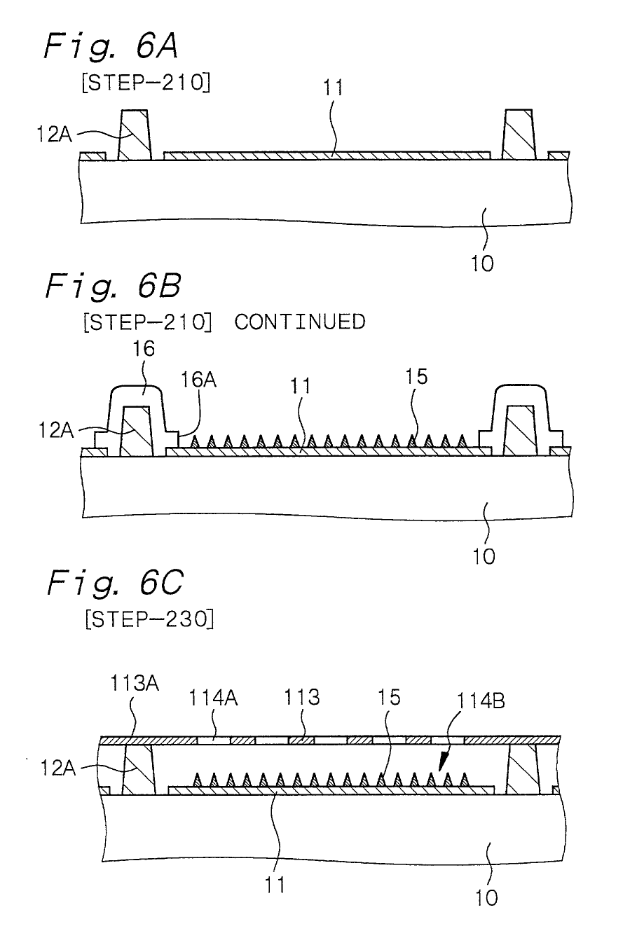

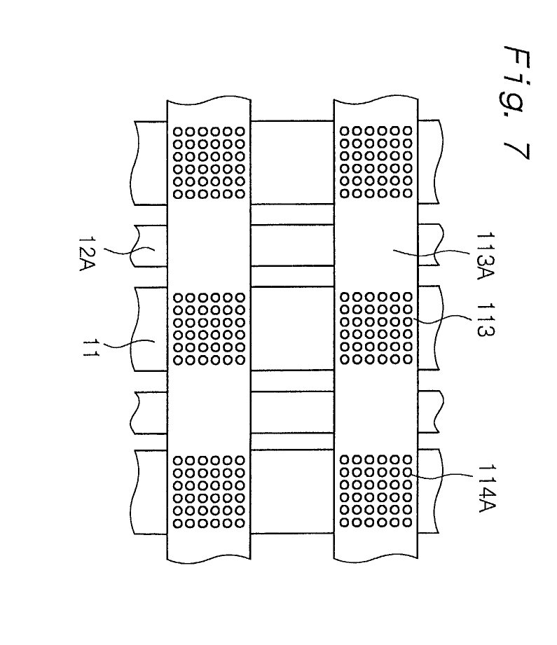

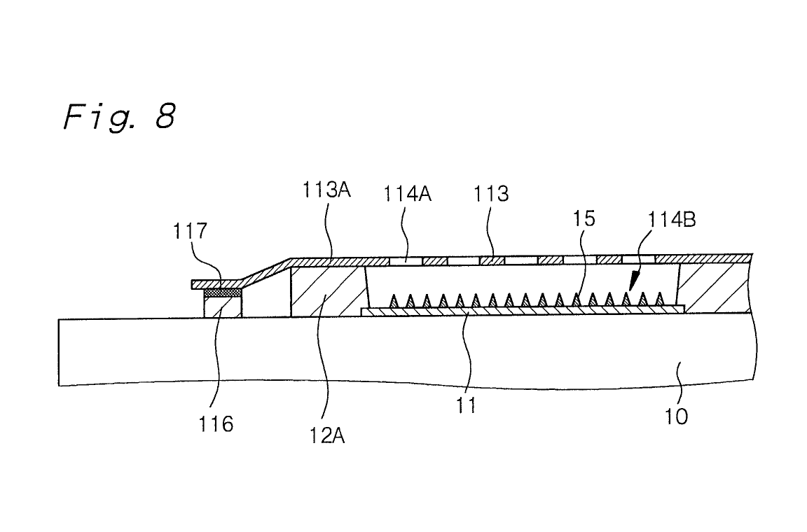

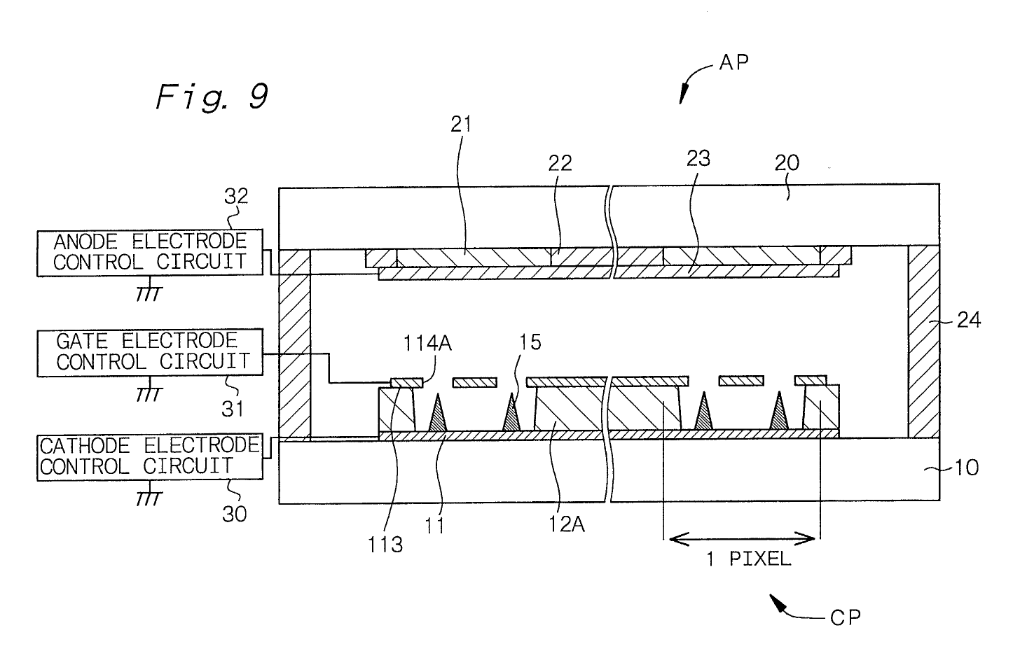

FIG. 9 shows a schematic partial end view of the display in Example 2, FIG. 6C and FIG. 8 show schematic partial cross-sectional views of the field emission device, and FIG. 7 shows a layout of the separation walls, the cathode electrodes and the gate electrodes in the field emission devices. While FIG. 9 shows one electron emitting portion 15 exposed in the bottom of an opening portion 114A, many electron emitting portions 15 are exposed in an actual embodiment.

In Example 2, as is shown in the schematic partial cross-sectional view of FIG. 6C, the field emission device further has a gate electrode 113 having an opening portion 114A, and the electron emitting portions 15 are selectively formed on that portion of the cathode electrode 11 that is positioned in the bottom of the opening portion 114A. The gate electrodes 113 are supported with stripe-shaped separation walls (ribs) 12A. The electron-emitting device, the field emission device and the display in Example 2 are the same as those in Example 1 except for the above points, so that detailed explanations of these are omitted.

The method of producing the field emission device and the method of producing the display in Example 2, which are the production method according to the first constitution A of the present invention, will be explained with reference to FIGS. 6A to 6C. In Example 2, the field emission device is produced by the steps of;

forming the cathode electrode 11 on the support member 11,

selectively forming the conical electron emitting portion 15 made of carbon on the surface of the cathode electrode 11, and

forming the gate electrode 113 having the opening portion 114A over the electron emitting portion 15.

[Step-200]

First, the stripe-shaped separation walls 12A for constituting gate electrode supports are formed on the support member 10, for example, by a sand blasting method.

[Step-210]

Then, a resist material layer is formed on the entire surface by a spin coating method, and the resist material layer is removed from a region which is between the separation walls 12A and 12A and on which the cathode electrode is to be formed. Then, an electrically conductive layer made of nickel (Ni) for the cathode electrode is formed on the entire surface in the same manner as in

[Step-100] in Example 1 and then the resist material layer is removed, whereby the electrically conductive layer for the cathode electrode, formed on the resist material layer, is also removed, and the stripe-shaped cathode electrode 11 extending in parallel with the separation walls 12A is left between the separation walls 12A (see FIG. 6A). A space between the separation walls 12A will be referred to as a second opening portion 114B.

[Step-220]

Then, a mask layer 16 made of a resist material is formed on the entire surface, and a hole portion 16A is formed in the mask layer 16 by photolithography. The hole portion 16A having a nearly rectangular form is positioned in that region of the cathode electrode 11 on which the electron emitting portions are to be formed. Then, a step similar to

[Step-120] is carried out (see FIG. 6B). Many electron emitting portions 15 are formed on the cathode electrode 11.

[Step-230]

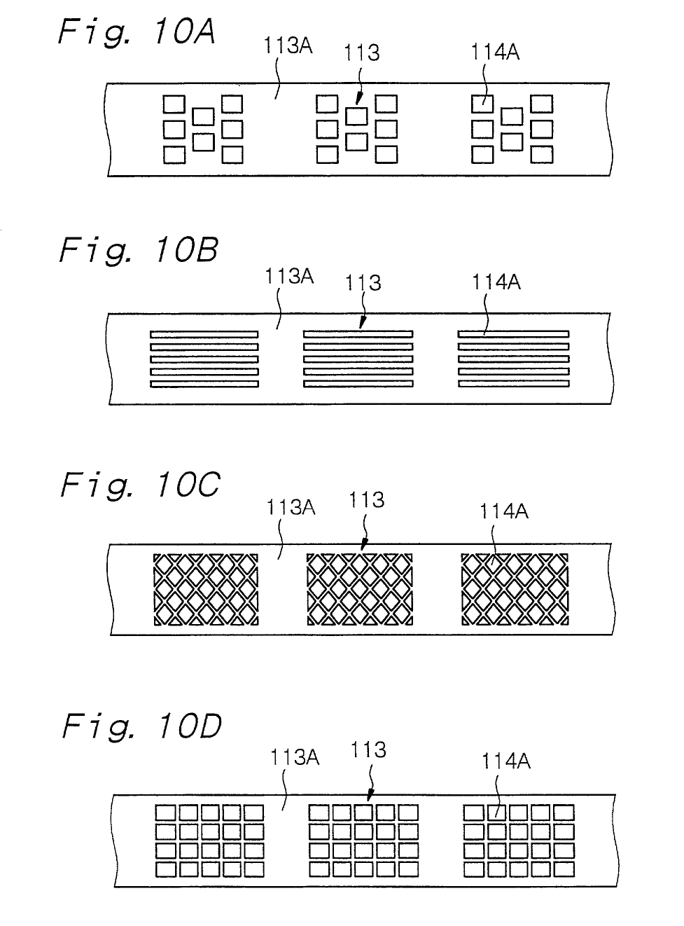

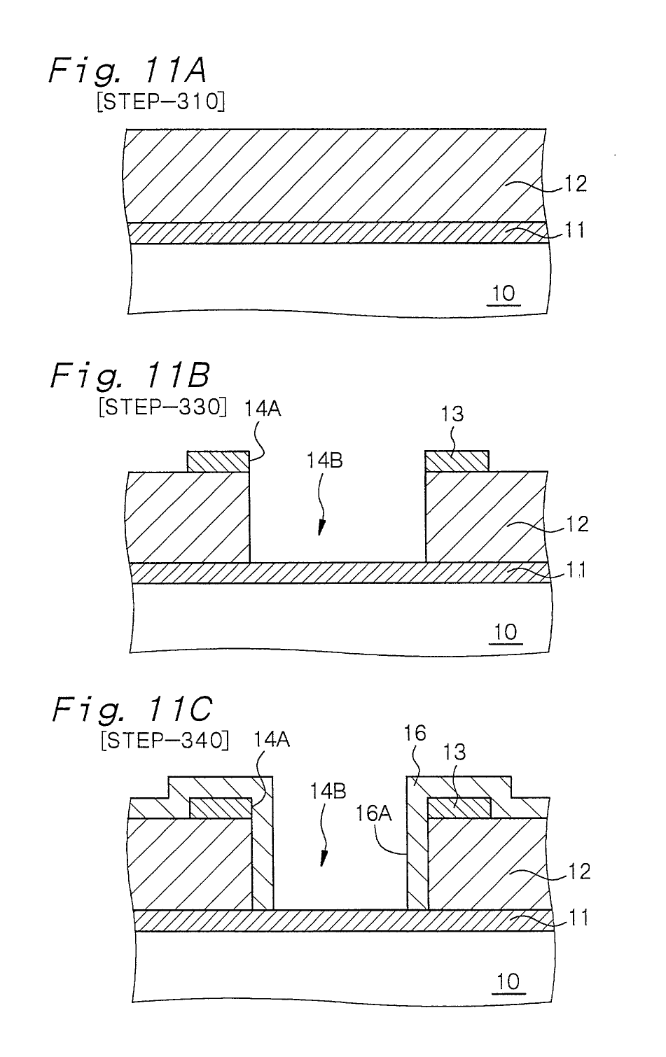

A stripe-shaped material layer (metal foil) 113A having opening portions 114A as shown in the schematic partial plan view of FIG. 7 or FIGS. 10A to 10D is prepared. And, in a state where the stripe-shaped material layer 113A is stretched such that it is in contact with the top surfaces of the separation walls 12A and that the opening portions 114A are positioned over the electron emitting portions 15, the stripe-shaped material layer 113A is fixed to the top surfaces of the separation walls 12A with a thermosetting adhesive (for example, epoxy adhesive) (see FIG. 6C), whereby the gate electrode 113 can be formed over the electron emitting portion 15. Alternatively, as shown in the schematic partial cross-sectional view of a vicinity of end portion of the support member 10 in FIG. 8, there may be employed a structure in which both ends of the stripe-shaped material layer 113A is fixed to the vicinities of the support member 10. More specifically, for example, projection portions 116 are formed beforehand in circumferential portions of the support member 10, and thin layers 117 made of the same material as that of the stripe-shaped material layer 113A are formed on the top surfaces of the projection portions 116 in advance. And, in a state in which the stripe-shaped material layer 113A is stretched, it is welded to the thin layers 117 with a laser, whereby the gate electrode 113 having the opening portions 114A can be formed over the electron emitting portions 15. The projection portions 116 can be formed, for example, simultaneously with the formation of the separation walls 12A. The above stripe-shaped material layer 113A is fixed such that the projection image of the stripe-shaped material layer 113A and the projection image of the cathode electrode 11 cross each other at right angles.

[Step-240]

Then, a step similar to the

[Step-130] in Example 1 is carried out to complete the display. When the gate electrode is provided, generally the distance between the cathode panel CP and the anode panel AP is adjusted to approximately 1 mm with a frame 24.

In the display in Example 2, a relatively negative voltage is applied to the cathode electrode 11 from a cathode electrode control circuit 30, a relatively positive voltage is applied to the gate electrode 113 from a gate electrode control circuit 31, and a positive voltage having a far higher level than the voltage to be applied to the gate electrode 113 is applied to the anode electrode 23 from an anode electrode control circuit 32. When such a display is used for displaying, for example, a scanning signal is inputted to the cathode electrode 11 from the cathode electrode control circuit 30, and a video signal is inputted to the gate electrode 113 from the gate electrode control circuit 31. The brightness of the display is controlled by a voltage to be applied to the cathode electrode 11. Electrons are emitted from the electron emitting portions 15 on the basis of a quantum tunnel effect under an electric field generated by applying a voltage between the cathode electrode 11 and the gate electrode 113, and the electrons are attracted toward the anode electrode 23 to collide with the phosphor layer 21. As a result, the phosphor layer 21 emits light, and desired images can be obtained.

### EXAMPLE 3

Example 3 is concerned with the field emission device according to the second constitution and the display according to the second constitution, and it is also concerned with the production method according to the first constitution B of the present invention.

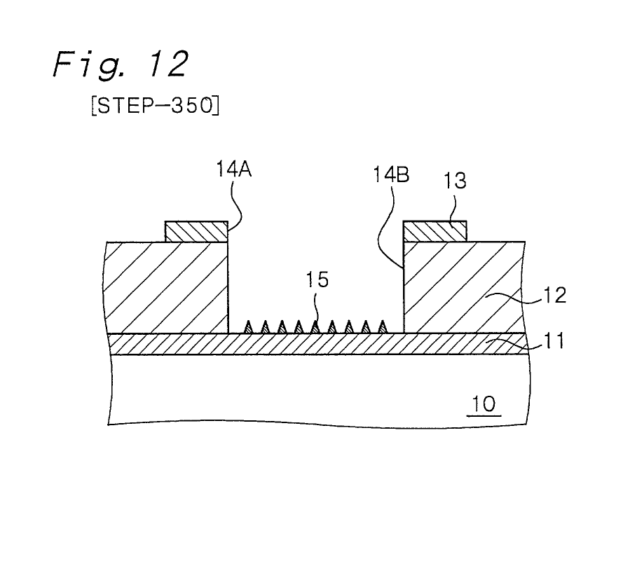

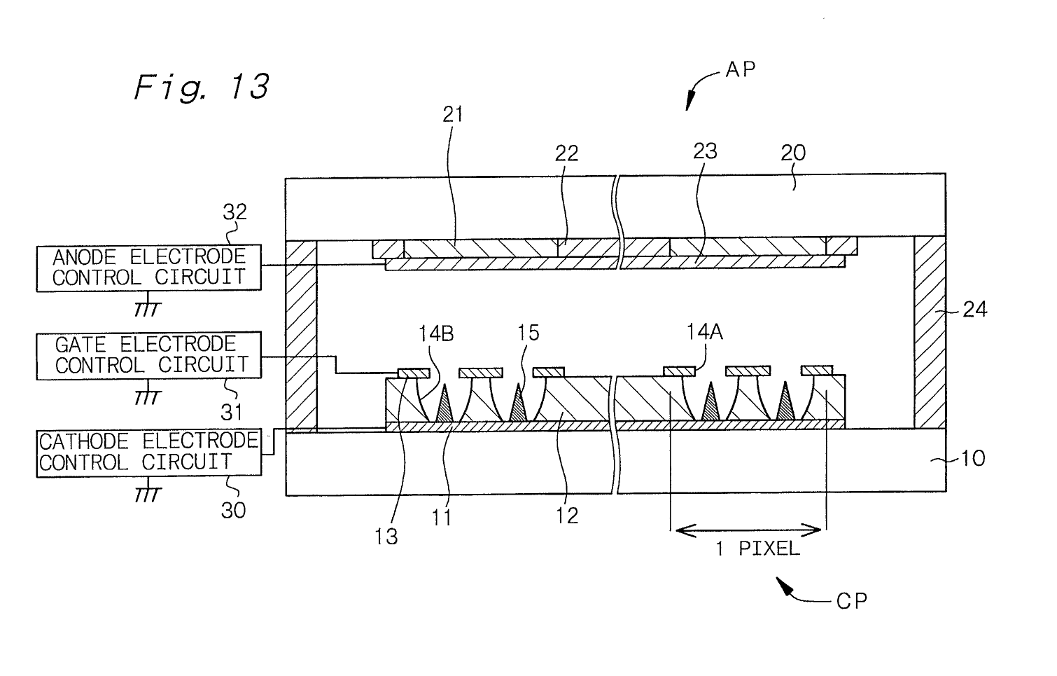

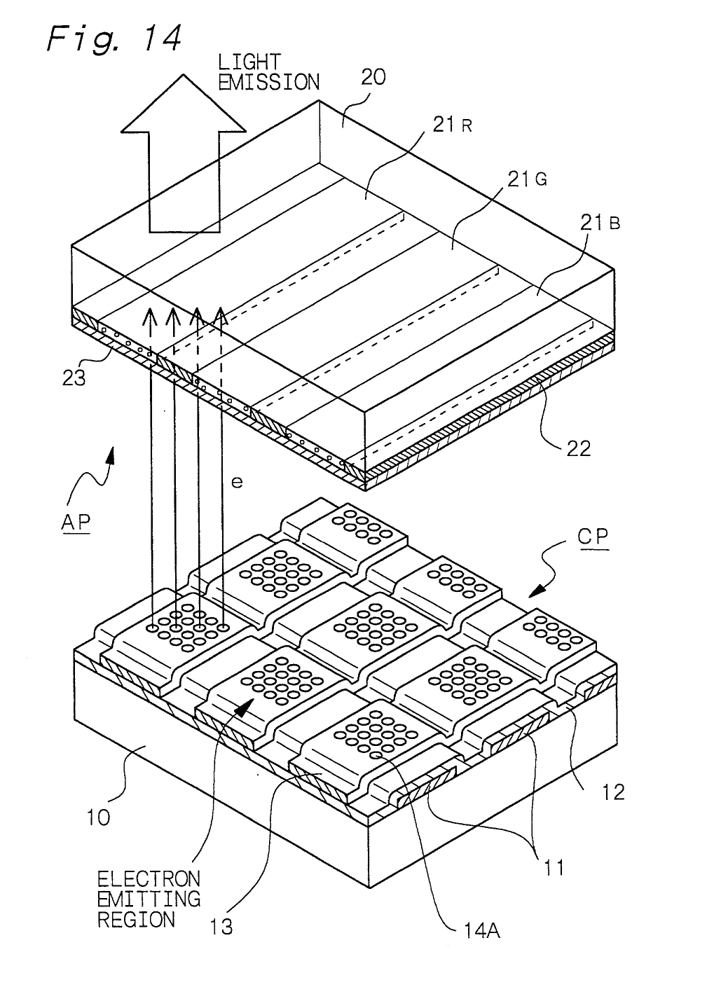

In Example 3, as is shown in the schematic partial end view of FIG. 12, an insulating layer 12 is formed on the support member 10 and the cathode electrode 11, a gate electrode 13 is formed on the insulating layer 12, a second opening portion 14B communicating with a first opening portion 14A formed in the gate electrode 13 is formed in the insulating layer 12, and electron emitting portions 15 are exposed in the bottom of the second opening portion 14B. The electron-emitting device, the field emission device and the display in Example 3 can be constitutionally the same as those in Example 1 except for the above points, so that detailed explanations thereof are omitted. FIG. 13 shows a schematic partial end view of the display in Example 3, and FIG. 14 shows a schematic exploded perspective view of the display. While FIG. 13 shows one electron emitting portion 15 exposed in the bottom of the second opening portion 14B, many electron emitting portions 15 are exposed in an actual embodiment.

The method of producing the field emission device and the method of producing the display in Example 3, which are production methods according to the first constitution B of the present invention, will be explained with reference to FIGS. 11A to 11C and 12. In Example 3, the field emission device can be formed by the steps of;

forming the cathode electrode 11 on the support member 10,

forming the insulating layer 12 on the support member 10 and the cathode electrode 11,

forming the gate electrode 13 having the first opening portion 14A on the insulating layer 12,

forming, in the insulating layer 12, the second opening portion 14B communicating with the first opening portion 14A formed in the gate electrode 13, and

selectively forming the conical electron emitting portion 15 made of carbon on that surface of the cathode electrode 11 which is positioned in the bottom of the second opening portion 12.

[Step-300]

The stripe-shaped cathode electrode 11 made of Ni is formed on the support member 10 in the same manner as in

[Step-100] in Example 1. The stripe-shaped cathode electrode 11 is extending rightward and leftward on the paper surface of the drawing.

[Step-310]

Then, a 3 μm thick insulating layer 12 made of SiO₂ is formed on the support member 10 and the cathode electrode 11, for example, by a TEOS CVD method (see FIG. 11A).

[Step-320]

Then, the gate electrode 13 having the first opening portion 14A is formed on the insulating layer 12. Specifically, for example, an aluminum layer is formed on the entire surface by a sputtering method, and the aluminum layer is patterned by photolithography and a dry etching method, whereby the stripe-shaped gate electrode 13 made of aluminum can be formed. The above gate electrode 13 has a pattern made such that the projection image of the gate electrode 13 and the projection image of the cathode electrode 11 cross each other at right angles.

[Step-330]

Then, a resist material layer is formed on the entire surface, and a hole portion is formed in a portion where the first opening portion 14A is to be formed in the resist material layer. And, the gate electrode 13 is dry-etched with using the resist material layer as an etching mask, to form the first opening portion 14A in the gate electrode 13. Further, the second opening portion 14B is formed in the insulating layer 12 positioned under the first opening portion 14A, and then the resist material layer is removed (see FIG. 11B).

[Step-340]

Then, a mask layer-16 made of a resist material is formed on the entire surface, and a hole portion 16A is formed in that portion of the mask layer 16 which is positioned in the central portion of the cathode electrode 11 exposed in the bottom of the second opening portion 14B by photolithography, in the same manner as in

[Step-110] in Example 1 (see FIG. 11C).

[Step-350]

The conical electron emitting portions 15 made of carbon are formed on the surface of the cathode electrode 11 positioned in the bottom of the second opening portion 14B by carrying out a step similar to the

[Step-120] in Example 1, and then the mask layer 16 is removed, whereby a structure shown in FIG. 12 can be obtained. Then, the display is completed by carrying out a step similar to

[Step-130] in Example 1.

### EXAMPLE 4

Example 4 is concerned with the field emission device according to the second constitution and the display according to the second constitution, and it is also concerned with the production method according to the first constitution C of the present invention. The field emission device in Example 4 is structurally the same as that explained in Example 3, so that detailed explanations thereof are omitted.

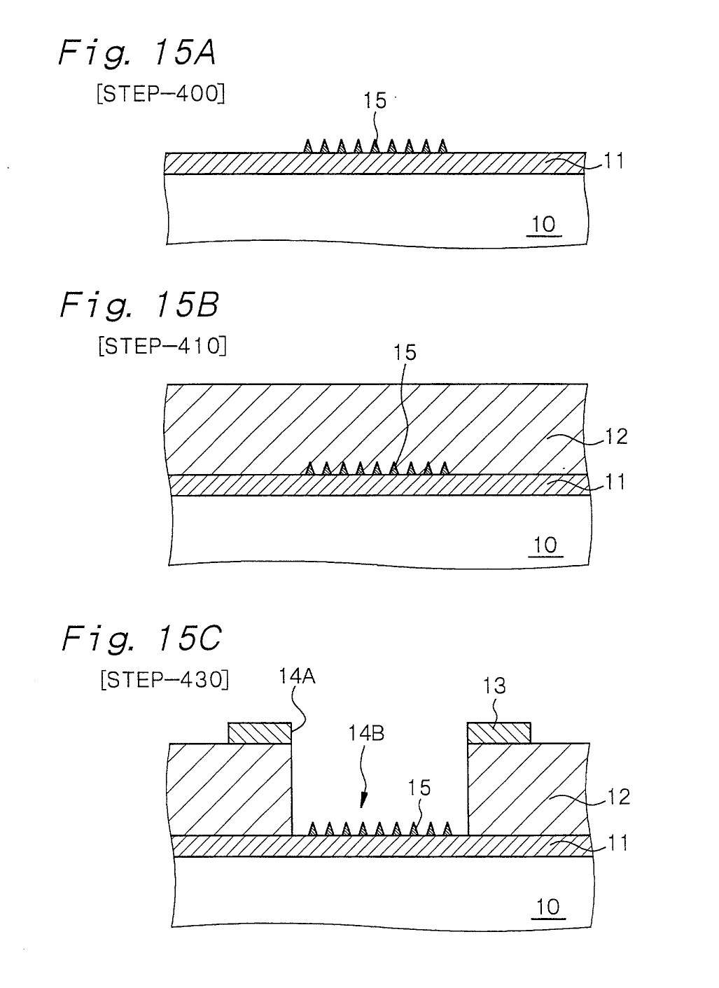

The method of producing the field emission device and the method of producing the display in Example 4, which are production methods according to the first constitution C of the present invention, will be explained with reference to FIGS. 15A to 15C hereinafter. In Example 4, the field emission device is formed by the steps of;

forming the cathode electrode 11 on the support member 10,

selectively forming the conical electron emitting portion 15 made of carbon on the surface of the cathode electrode 11,

forming an insulating layer 12 on the support member 10 and the electron emitting portion 15 (and further, on the cathode electrode 11),

forming the gate electrode 13 having the first opening portion 14A on the insulating layer 12, and

forming, in the insulating layer 12, the second opening portion 14B which communicates with the first opening portion 14A formed in the gate electrode 13 and in a bottom of which the electron emitting portions 15 is exposed.

[Step-400]

The cathode electrode 11 made of Ni is formed on the support member 10 in the same manner as in

[Step-100] in Example 1, and then the electron emitting portions 15 are selectively formed in the same manner as in

[Step-110] and

[Step-120] in Example 1 (see FIG. 15A).

[Step-410]

A 3 μm thick insulating layer 12 made of SiO₂ is formed on the entire surface (specifically, on the support member 10, the cathode electrode 11 and the electron emitting portions 15), for example, by a TEOS CVD method (see FIG. 15B).

[Step-420]

Then, the gate electrode 13 having the first opening portion 14A is formed on the insulating layer 12. Specifically, for example, an aluminum layer is formed on the entire surface by a sputtering method and the aluminum layer is patterned by photolithography and a dry etching method, whereby the stripe-shaped gate electrode 13 made of aluminum can be formed. The above gate electrode 13 has a pattern made such that the projection image of the gate electrode 13 and the projection image of the cathode electrode 11 cross each other at right angles.

[Step-430]

Then, a resist material layer is formed on the entire surface, and a hole portion is formed in the resist material layer in a portion where the first opening portion 14A is to be formed. And, the gate electrode 13 is dry-etched with using the above resist material layer as an etching mask, to form the first opening portion 14A in the gate electrode 13, and further, the second opening portion 14B is formed in the insulating layer 12 positioned under the first opening portion 14A, whereby the electron emitting portions 15 are exposed in the bottom of the second opening portion 14B. Then, the resist material layer is removed, to give the field emission device shown in FIG. 15C.

[Step-440]

A step similar to

[Step-130] in Example 1 is carried out, to complete the display.

### EXAMPLE 5

Example 5 is a variant of Example 1, and is concerned with the production method according to the second aspect of the present invention.

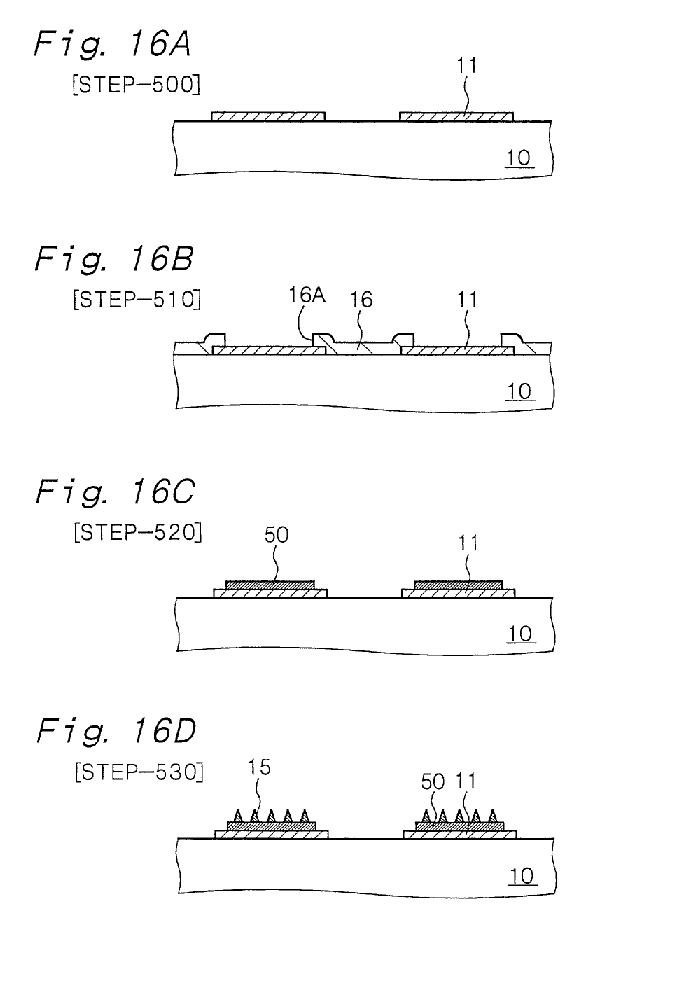

In Example 5, as is shown in the schematic partial end view of FIG. 16D, an electron-emitting-portion-forming layer 50 made of a metal thin layer (specifically, nickel thin layer in Example 5) is selectively formed between an electrically conductive layer or the cathode electrode 11 and the electron emitting portions 15. The electron-emitting device, the field emission device and the display in Example 5 are constitutionally the same as those in Example 1, so that detailed explanations thereof are omitted.

In Example 5, aluminum (Al) was used as a material for constituting the electrically conductive layer or the cathode electrode 11, and nickel (Ni) was used as a material for constituting the electron-emitting-portion-forming layer 50.

The method of producing the field emission device and the method of producing the display in Example 5 will be explained with reference to FIGS. 16A to 16D. In Example 5, the field emission device is formed by the steps of;

forming the cathode electrode 11 on the support member 10,

forming the electron-emitting-portion-forming layer 50 on the cathode electrode 11, and

forming the conical electron emitting portion 15 made of carbon on the electron-emitting-portion-forming layer 50.

[Step-500]

First, an electrically conductive layer for forming the cathode electrode is formed on the support member 10 made, for example, of a glass substrate. Then, the electrically conductive layer is patterned by lithography and a reactive ion etching method (RIE method), to form the cathode electrode 11 having a nearly rectangular form and the wiring 11A (not shown) on the support member 10 (see FIG. 16A). The cathode electrode 11 and the wiring 11A are, for example, an approximately 0.2 μm thick aluminum (Al) layer formed by a sputtering method.

[Step-510]

Then, a mask layer 16 made of a resist material is formed on the entire surface, and a hole portion 16A is formed in the mask layer 16 by photolithography (see FIG. 16B). The hole portion 16A is positioned in the central portion of the nearly rectangular cathode electrode 11.

[Step-520]

Then, a nickel layer is formed on the entire surface under the same condition as that shown in

[Step-100] in Example 1, and then the mask layer 16 is removed by a lift-off method, whereby the electron-emitting-portion-forming layer 50 can be formed in the desired portion of surface of the cathode electrode 11 as shown in FIG. 16C.

[Step-530]

Then, the conical electron emitting portions 15 made of carbon are formed on the electron-emitting-portion-forming layer 50 in the same manner as in

[Step-120] in Example 1 as shown in FIG. 16D. No electron emitting portions are formed on the exposed cathode electrode 11 made of aluminum.

The conical electron emitting portions 15 can be formed even at a lower temperature (for example, 100° C.) depending upon a plasma CVD condition (particularly, bias voltage to the support member 10, plasma density, electron temperature and ion current density) and the surface condition of the electron-emitting-portion-forming layer 50 that is a substratum. The synthesis condition may be changed as required for varying crystallinity of carbon constituting the electron emitting portions. Further, for improving electron emission properties, a natural oxide layer on the surface of the electron-emitting-portion-forming layer 50 may be removed, for example, by a plasma reducing treatment using hydrogen (H₂) or ammonia (NH₃), a sputtering treatment in an argon (Ar) or helium (He) atmosphere or a washing treatment using an acid such as hydrofluoric acid or a base, before the formation of the electron emitting portions 15. This is also applicable to various methods to be explained hereinafter.

[Step-540]

Then, the display is completed in the same manner as in

[Step-130] in Example 1.

In the display having the above constitution, the electron emitting portions of the field emission device formed on the electron-emitting-portion-forming layer 50 are made of cones-shaped carbon having a low work function, and processing thereof does not require any complicated or advanced processing techniques that are required for a conventional Spindt type field emission device. Moreover, the electron emitting portions 15 are selectively formed on the electron-emitting-portion-forming layer 50, and no etching of the carbon is required. When the effective field of the display is therefore increased and when the number of the electron emitting portions formed is greatly increased, the electron emission efficiency of the electron emitting portions can be made uniform on the entire region of the effective field, and there can be realized a display that attains high-quality images in which no or little brightness non-uniformity takes place.

An Example 1 variant having a constitution of the stripe-shaped cathode electrode and the stripe-shaped anode electrode can be applied to Example 5.

### EXAMPLE 6

Example 6 is a variant of Example 2 and is concerned with the field emission device according to the third constitution and the display according to the third constitution, and it is also concerned with the production method according to the second constitution D of the present invention.

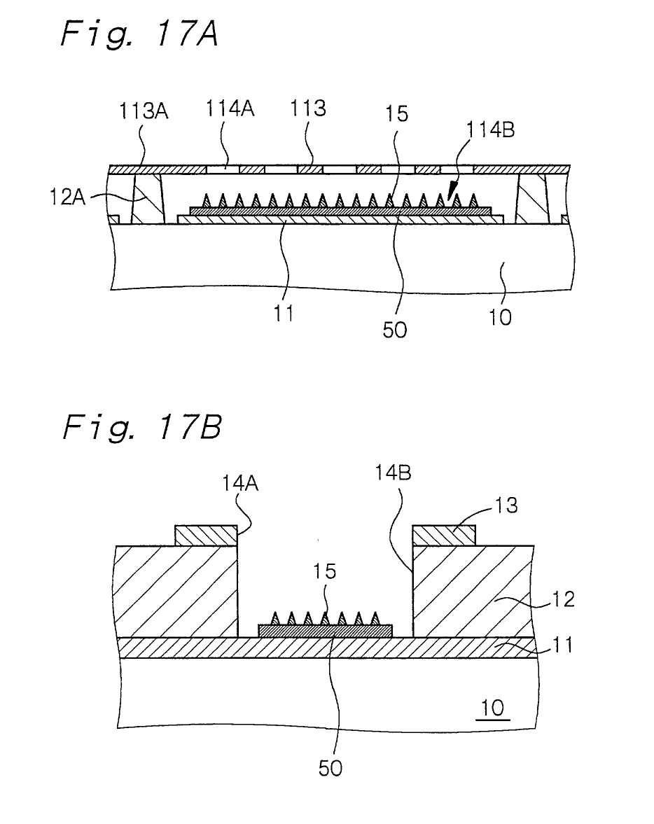

As is shown in the schematic partial cross-sectional view of the field emission device in FIG. 17A, the field emission device has a gate electrode 113 having an opening portion 114A, an electron-emitting-portion-forming layer 50 is formed on the surface of that portion of the cathode electrode 11 which is positioned in the bottom of the opening portion 114A, and the electron emitting portion 15 is formed on the electron-emitting-portion-forming layer 50. The gate electrode 113 is supported with stripe-shaped separation walls (ribs) 12A. The electron-emitting device, the field emission device and the display in Example 6 are constitutionally the same as those in Example 2, so that detailed explanations thereof are omitted.

The method of producing the field emission device and the method of producing the display of Example 6 according to the second constitution D of the present invention will be explained hereinafter. In Example 6, the field emission device is formed by the steps of;

forming the cathode electrode 11 on the support member 10,

forming the electron-emitting-portion-forming layer 50 on the cathode electrode 11,

forming the conical electron emitting portion 15 made of carbon on the electron-emitting-portion-forming layer 50, and

forming the gate electrode 113 having the opening portion 114A over the electron emitting portions 15.

[Step-600]

Separation walls 12A for constituting gate electrode supports are formed on the support member 10, for example, by a sand blasting method.

[Step-610]

Then, the cathode electrode 11, the electron-emitting-portion-forming layer 50 and the electron emitting portions 15 are formed on the support member 10. Specifically, a resist material layer is formed on the entire surface by a spin coating method, and the resist material layer is removed from a region which is between the separation walls 12A and 12A and on which the cathode electrode is to be formed. Then, an electrically conductive layer made of aluminum (Al) for the cathode electrode is formed on the entire surface by a sputtering method in the same manner as in

[Step-500] in Example 5, and then the resist material layer is removed, whereby the electrically conductive layer for the cathode electrode, formed on the resist material layer, is also removed to leave the stripe-shaped cathode electrode 11 between the separation walls 12A and 12A, which cathode electrode 11 is extending in parallel with the separation walls 12A.

[Step-620]

Then, in the same manner as in

[Step-510] to

[Step-530] in Example 5, an electron-emitting-portion-forming layer 50 is selectively formed on the cathode electrode 11, and then conical electron emitting portions 15 made of carbon are formed on the electron-emitting-portion-forming layer 50. Then, a step similar to [Step-230] in Example 2 is carried out to complete the field emission device, and a step similar to

[Step-240] in Example 2 is carried out to complete the display.

### EXAMPLE 7

Example 7 is a variant of Example 3, and is concerned with the field emission device according to the fourth constitution and the display according to the fourth constitution, and it is also concerned with the production method according to the second constitution C of the present invention.

In Example 7, as is shown in the schematic partial end view of FIG. 17B, an insulating layer 12 is formed on the support member 10 and the cathode electrode 11, a gate electrode 13 is formed on the insulating layer 12, a second opening portion 14B communicating with a first opening portion 14A formed in the gate electrode 13 is formed in the insulating layer 12, and electron emitting portion 15 is exposed in the bottom of the second opening portion 14B. An electron-emitting-portion-forming layer 50 is formed on the surface of that portion of the cathode electrode 11 which is positioned in the bottom of the second opening portion 14B, and the electron emitting portions 15 are formed on the electron-emitting-portion-forming layer 50. The electron-demitting device, the field emission device and the display in Example 7 are constitutionally the same as those in Example 3, so that detailed explanations thereof are omitted.

The method of producing the field emission device and the method of producing the display in Example 7, which are the production method according to the second constitution C of the present invention, will be explained hereinafter. In Example 7, the field emission device is formed by the steps of;

forming the cathode electrode 11 on the support member 10,

forming the insulating layer 12 on the support member 10 and the cathode electrode 11,

forming the gate electrode 13 having the first opening portion 14A on the insulating layer 12,

forming, in the insulating layer 12, the second opening portion 14B communicating with the first opening portion 14A formed in the gate electrode 13,

forming the electron-emitting-portion-forming layer 50 on the cathode electrode 11 positioned in the bottom of the second opening portion 14B, and

forming the conical electron emitting portion 15 made of carbon on the electron-emitting-portion-forming layer 50.

[Step-700]

First, the cathode electrode 11 is formed on the support member 10. Specifically, a stripe-shaped cathode electrode 11 made of aluminum (Al) is formed on the support member 10 in the same manner as in

[Step-500] in Example 5. Then, the insulating layer 12 is formed on the support member 10 and the cathode electrode 11, and then the gate electrode 13 having the first opening portion 14A is formed on the insulating layer 12. Then, the second opening portion 14B communicating with the first opening portion 14A formed in the gate electrode 13 is formed in the insulating layer 12. Specifically, steps similar to

[Step-310] to

[Step-330] in Example 3 are carried out.

[Step-710]

Then, the electron-emitting-portion-forming layer 50 is selectively formed on the cathode electrode 11. In Example 7, the electron-emitting-portion-forming layer 50 is selectively formed on the cathode electrode 11 positioned in the bottom of the second opening portion 14B. Specifically, a mask layer made of a resist material is formed on the entire surface, and a hole portion is formed in that portion of the mask layer 16 which is positioned in the central portion of the cathode electrode 11 exposed in the bottom of the second opening portion 14B by photolithography, in the same manner as in

[Step-340] in Example 3. Then, a nickel layer is formed on the entire surface under the same condition as that shown in

[Step-100] in Example 1, and the mask layer is removed.

[Step-720]

Then, a step similar to

[Step-120] in Example 1 is carried out to selectively form the conical electron emitting portions 15 made of carbon on the electron-emitting-portion-forming layer 50 positioned in the bottom of the second opening portion 14B. Then, a step similar to

[Step-130] in Example 1 is carried out to complete the display. For forming the electron emitting portions 15, it is sufficient to employ a plasma CVD condition under which no electron emitting portions 15 are formed on the gate electrode 13.

### EXAMPLE 8

Example 8 is a variant of Example 6 and is concerned with the field emission device according to the third constitution and the display according to the third constitution, and it is also concerned with the production method according to the second constitution A of the present invention. That is, in Example 8, the field emission device is formed by the steps of;

forming the cathode electrode 11 on the support member 10,

forming the electron-emitting-portion-forming layer 50 on the cathode electrode 11,

forming a gate electrode 113 having an opening portion 114A over the electron-emitting-portion-forming layer 50, and

forming the conical electron emitting portion 15 made of carbon on the electron-emitting-portion-forming layer 50 under the opening portion 114A.

The method of producing the field emission device and the method of producing the display in Example 8 will be explained hereinafter.

[Step-800]

First, separation walls 12A that are to constitute gate electrode supports are formed on the support member 10, for example, by a sand blasting method in the same manner as in

[Step-600] in Example 6.

[Step-810]

Then, the cathode electrode 11 and the electron-emitting-portion-forming layer 50 are formed on the support member 10. Specifically, a resist material layer is formed on the entire surface by a spin coating method, and the resist material layer in a region between the separation walls 12A and 12A is removed. In the region between the separation walls 12A and 12A, the cathode electrode is to be formed. An electrically conductive layer made of aluminum (Al) for the cathode electrode is formed on the entire surface by a sputtering method in the same manner as in

[Step-500] in Example 5, and then the resist material layer is removed, whereby the electrically conductive layer for the cathode electrode, formed on the resist material layer, is removed to leave the cathode electrode 11 between the separation walls 12A and 12A. The cathode electrode 11 is extending in parallel with the separation walls 12A.

[Step-820]

Then, a mask layer made of a resist material is formed on the entire surface by a spin coating method, and the mask layer on the cathode electrode 11 in a region between the separation walls 12A and 12A is removed. The region is where the electron-emitting-portion-forming layer 50 is to be formed. Then, a nickel layer is formed on the entire surface in the same manner as in

[Step-100] in Example 1, and then the mask layer is removed, whereby the nickel layer formed on the mask layer is removed, and the electron-emitting-portion-forming layer 50 made of the nickel layer formed on the cathode electrode 11 between the separation walls 12A and 12A is selectively retained.

[Step-830]

Then, a step similar to

[Step-230] in Example 2 is carried out to form the gate electrode 113 having the opening portion 114A over the electron-emitting-portion-forming layer 50.

[Step-840]

Then a step similar to

[Step-120] in Example 1 is carried out to selectively form the conical electron emitting portions 15 made of carbon on the electron-emitting-portion-forming layer 50 under the opening portion 114A, whereby the field emission device as shown in FIG. 17A can be obtained. Then, a step similar to

[Step-130] in Example 1 is carried out to complete the display.

### EXAMPLE 9

Example 9 is a variant of Example 7 and is concerned with the field emission device according to the fourth constitution and the display according to the fourth constitution, and it is also concerned with the production method according to the second constitution B of the present invention. That is, in Example 9, the field emission device is formed by the steps of;

forming the cathode electrode 11 on the support member 11,

forming the electron-emitting-portion-forming layer 50 on the cathode electrode 11,

forming an insulating layer 12 on the support member 10 and the electron-emitting-portion-forming layer 50 (and also on the cathode electrode 11),

forming the gate electrode 13 having a first opening portion 14A on the insulating layer 12,

forming, in the insulating layer 12, a second opening portion 14B communicating with the first opening portion 14A formed in the gate electrode 13, and

forming the conical electron emitting portion 15 made of carbon on the electron-emitting-portion-forming layer 50 positioned in the bottom of the second opening portion 14B.

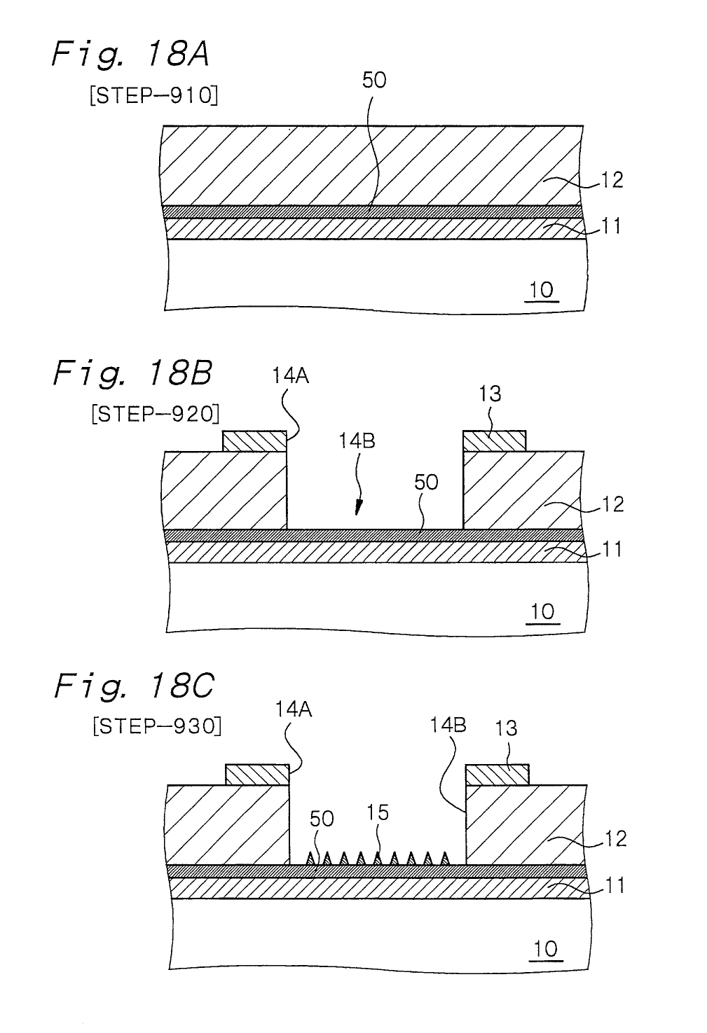

The method of producing the field emission device and the method of producing the display in Example 9 will be explained with reference to FIGS. 18A to 18C hereinafter.

[Step-900]

First, in the same manner as in

[Step-500] in Example 5, an aluminum layer is formed on the support member 10, and then a nickel layer is formed on the aluminum layer by a sputtering method under the same condition as that shown in

[Step-100] in Example 1. Then, the nickel layer and the aluminum layer are patterned, whereby the cathode electrode 11 and the electron-emitting-portion-forming layer 50 formed thereon can be obtained. The above cathode electrode 11 and the above electron-emitting-portion-forming layer 50 are extending leftward and rightward on the paper surface of the drawing.

[Step-910]

Then, a 3 μm thick insulating layer 12 made of SiO₂ is formed on the support member 10 and the electron-emitting-portion-forming layer 50, for example, by a TEOS CVD method (see FIG. 18A).

[Step-920]

Then, the gate electrode 13 having the first opening portion 14A is formed on the insulating layer 12 in the same manner as in

[Step-320] in Example 3, and the second opening portion 14B communicating with the first opening portion 14A formed in the gate electrode 13 is formed in the insulating layer 12 in the same manner as in

[Step-330]. The gate electrode 13 has a pattern made such that the projection image of the gate electrode 13 and the projection image of the cathode electrode 11 cross each other at right angles.

[Step-930]

Then, a step similar to

[Step-120] in Example 1 is carried out to form the conical electron emitting portions 15 made of carbon on the electron-emitting-portion-forming layer 50 positioned in the bottom of the second opening portion 14B. Then, a step similar to

[Step-130] in Example 1 is carried out to complete the display. For forming the electron emitting portions 15, it is sufficient to employ a plasma CVD condition under which no electron emitting portions 15 are formed on the gate electrode 13.

### EXAMPLE 10

Example 10 is also a variant of Example 7 and is concerned with the field emission device according to the fourth constitution and the display according to the fourth constitution, and it is also concerned with the production method according to the second constitution E of the present invention, That is, in Example 10, the field emission device is formed by the steps of;

forming the cathode electrode 11 on the support member 10,

forming the electron-emitting-portion-forming layer 50 on the cathode electrode 11,

selectively forming the conical electron emitting portion 15 made of carbon on the electron-emitting-portion-forming layer 50,

forming an insulating layer 12 on the support member 10 and the electron emitting portions 15 (and also on the electron-emitting-portion-forming layer 50),

forming the gate electrode 13 having a first opening portion 14A on the insulating layer 12, and

forming, in the insulating layer 12, a second opening portion 14B which communicates the first opening portion 14A formed in the gate electrode 13 and in a bottom of which the electron emitting portions 15 is exposed.

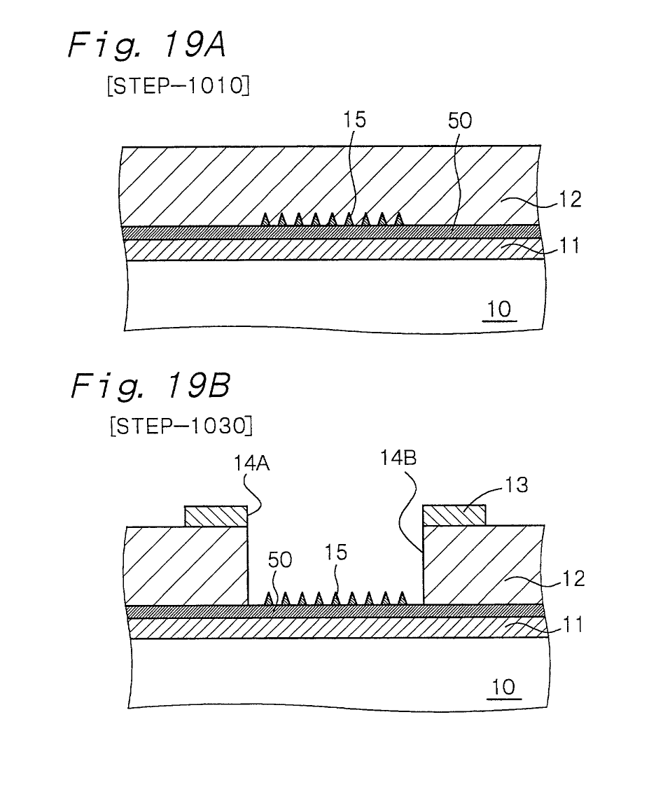

The method of producing the field emission device and the method of producing the display in Example 10 will be explained with reference to FIGS. 19A and 19B hereinafter.

[Step-1000]

First, an aluminum layer is formed on the support member 10 in the same manner as in

[Step-500] in Example 5, and then a nickel layer is formed on the aluminum layer by a sputtering method under the same condition as that shown in

[Step-100] in Example 1. Then, the nickel layer and the aluminum layer are patterned to obtain the cathode electrode 11 and the electron-emitting-portion-forming layer 50 formed thereon. The above cathode electrode 11 and the electron-emitting-portion-forming layer 50 are extending leftward and rightward on the paper surface of the drawing.

[Step-1010]

Then, steps similar to

[Step-110] and

[Step-120] in Example 1 are carried out, to selectively form the conical electron emitting portions 15 made of carbon on the electron-emitting-portion-forming layer 50.

[Step-1020]

Then, a 3 μm thick insulating layer 12 made of SiO₂ is formed on the entire surface (specifically, on the support member 10, the electron emitting portions 15 and further, exposed electron-emitting-portion-forming layer 50), for example, by a TEOS CVD method (see FIG. 19A).

[Step-1030]

Then, the gate electrode 13 having a first opening portion 14A is formed on the insulating layer 12 in the same manner as in

[Step-320] in Example 3, and a second opening portion 14B communicating with the first opening portion 14A formed in the gate electrode 13 is formed in the insulating layer 12 in the same manner as in

[Step-330] in Example 3, whereby the electron emitting portions 15 are exposed in the bottom of the second opening portion 14B (see FIG. 19B).

[Step-1040]

Then, a step similar to

[Step-130] in Example 1 is carried out to complete the display.

While the present invention has been explained with reference to Examples hereinabove, the present invention shall not be limited thereto. Specific structures of the electron-emitting devices, the cold cathode field emission devices and the cold cathode field emission displays, production conditions thereof and materials used therefor are all given for explanatory purposes and may be altered as required. In Examples, the nickel layer formed by a sputtering method is used for the cathode electrode or for the electron-emitting-portion-forming layer. However, the cathode electrode or the electron-emitting-portion-forming layer shall not be limited thereto, and any metal may be used so long as it has catalytic activity in an atmosphere employed for forming (synthesizing) the electron emitting portions. Further, the sputtering method may be replaced with a physical vapor deposition method (for example, an electron beam heating method or a vacuum vapor deposition method) or a plating method (for example, a plating method using a zinc plating solution or a tin plating solution). When the plating method is used, the formation of the electron-emitting-portion-forming layer on the gate electrode can be prevented by connecting the gate electrode to an anode electrode side. For forming the electron emitting portions made of carbon, the helicon CVD method may be replaced with an inductively coupled plasma CVD method, an electron cyclotron resonance plasma CVD method, or a capacitively coupled plasma CVD method.

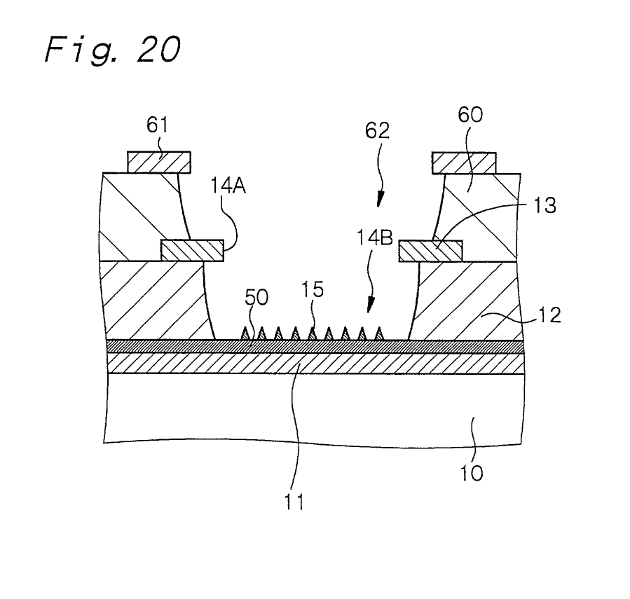

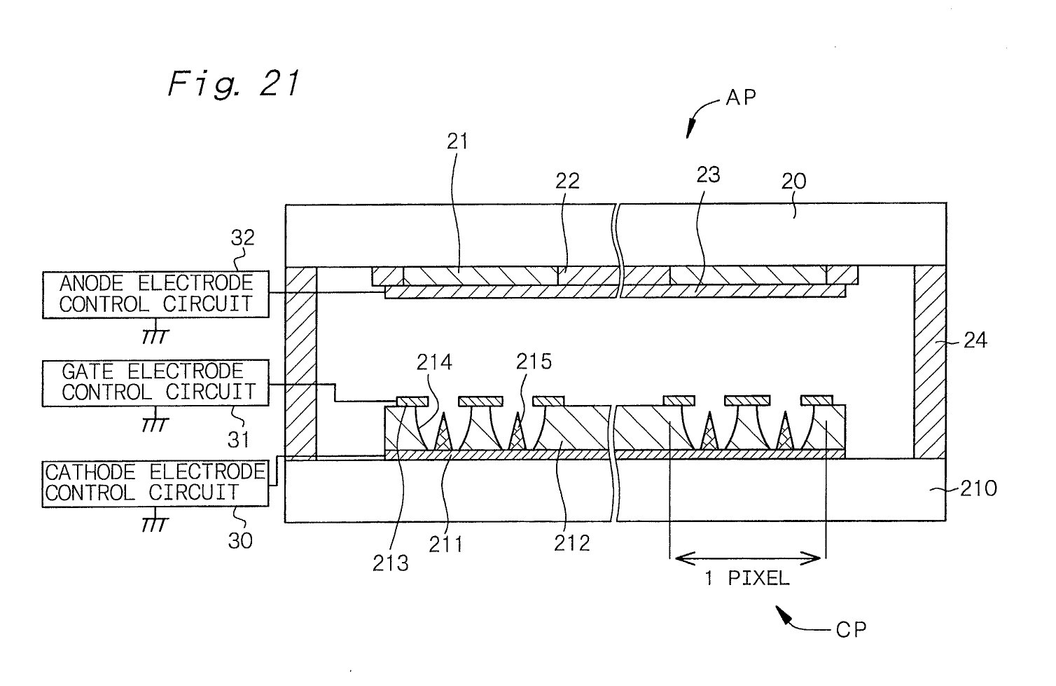

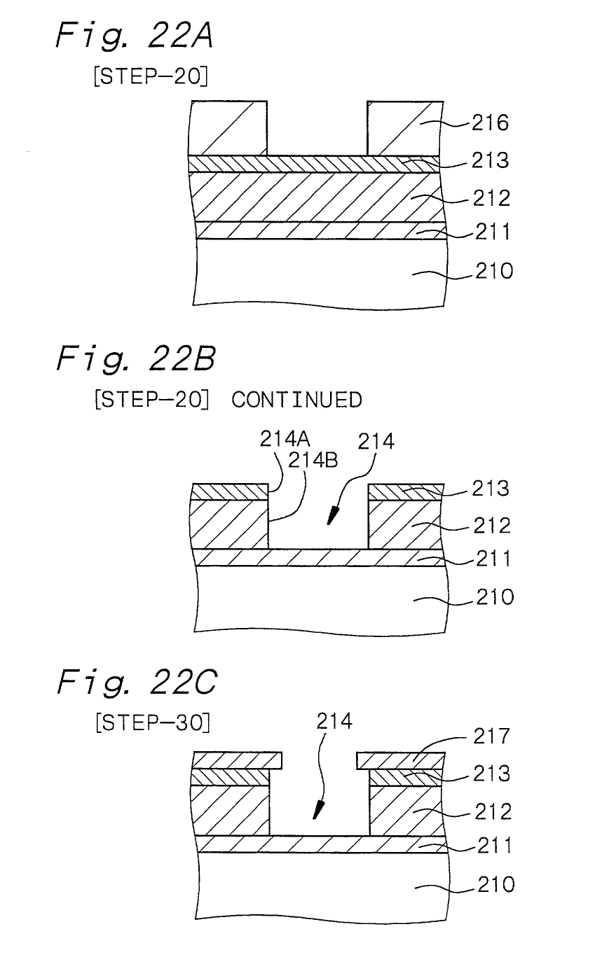

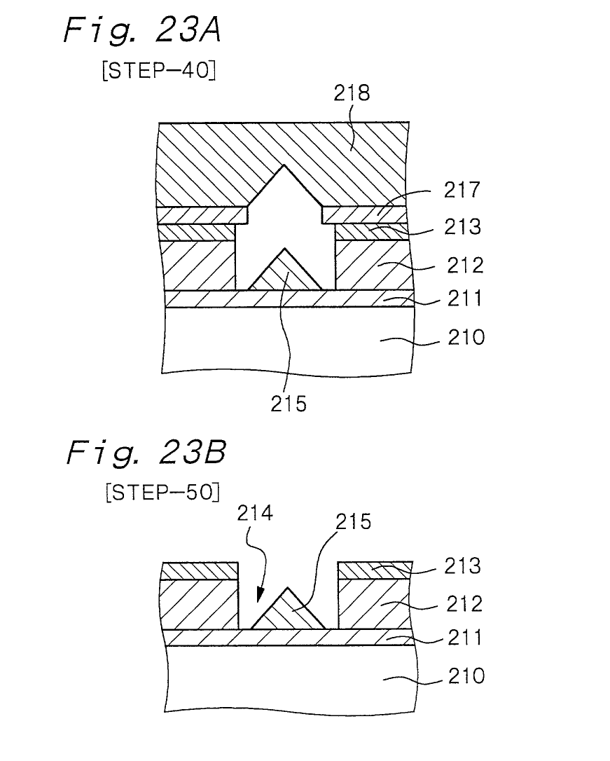

The cold cathode field emission device of the present invention may have a constitution in which a second insulating layer 60 is further formed on the gate electrode 13 and the insulating layer 12, and a focus electrode 61 is formed on the second insulating layer 60. FIG. 20 shows a schematic partial end view of the thus-constituted field emission device. The second insulating layer 60 has a third opening portion 62 communicating with the first opening portion 14A. The focus electrode 61 may be formed as follows. For example, the gate electrode 13 in the form of a stripe is formed on the insulating layer 12, then, the second insulating layer 60 is formed, then, a patterned focus electrode 61 is formed on the second insulating layer 60, the third opening portion 62 is formed in the focus electrode 61 and the second insulating layer 60, and further, the first opening portion 14A is formed in the gate electrode 13.

The electron-emitting device of the present invention can be applied to a device generally called a surface conduction type electron-emitting device. The above surface conduction type electron-emitting device comprises a support member made, for example, of glass and pairs of electrodes formed on the support member. The electrode is composed of an electrically conductive material such as tin oxide (SnO₂), gold (Au), indium oxide (In₂O₃)/tin oxide (SnO₂), carbon, palladium oxide (PdO), etc. The pair of the electrodes has a very small area and is arranged at a predetermined interval (gap). The pairs of the electrodes are formed in the form of a matrix. And, the surface conduction type electron-emitting device has a constitution in which a wiring in the row direction is connected to one of each pair of the electrodes and a wiring in the column direction is connected to the other of each pair of the electrodes. In the above surface conduction type electron-emitting device, an electron-emitting-portion-forming layer is formed on the surface of each pair of the electrodes (corresponding to the electrically conductive layer), and the conical electron emitting portions made of carbon are formed on the electron-emitting-portion-forming layer. When a voltage is applied to a pair of the electrodes, an electric field is exerted on the electron emitting portions opposed to each other through the gap, and electrons are emitted from the electron emitting portions. Such electrons are attracted toward the anode panel to collide with the phosphor layer on the anode panel, so that the phosphor layer is excited to emit light and gives a desired image.

The present invention employs the conical electron emitting portions made of carbon, so that electrons can be emitted under far lower electric fields, and remarkably high electron emission efficiency can be attained. In the present invention, further, the electron emitting portions can be selectively formed, so that it is not at all required to carry out patterning for forming the electron emitting portions having a desired form. Further, the electron emitting portions can be formed at a low temperature, so that a support member made, for example, of a glass substrate can be used without any problem. Further, electron emitting portions of a sub-micron order or finer order can be formed without using any highly accurate semiconductor production process, and the number of production steps can be decreased as compared with a process for producing conventional electron emitting portions. Further, cold cathode field emission displays operable with low power consumption can be obtained, and a large-screen cold cathode field emission display attaining high quality images and having a uniform brightness distribution can be provided.

What is claimed is:

1. An electron-emitting device having a conical electron emitting portion made of carbon on an electrically conductive layer.

2. The electron-emitting device according to claim 1, in which an electron-emitting-portion-forming layer is formed between the electrically conductive layer and the electron emitting portion.

3. The electron-emitting device according to claim 1, in which the value of H/(S/π)^{½} is 3 to 7 in which S is an area of bottom surface of the conical electron emitting portion and H is a height thereof.

4. A cold cathode field emission device comprising;
(A) a cathode electrode formed on a support member, and
(B) a conical electron emitting portion made of carbon and formed on the cathode electrode.

5. The cold cathode field emission device according to claim 4, in which a gate electrode having an opening portion is further provided, and the electron emitting portion is formed on that portion of the cathode electrode which is positioned in the bottom of the opening portion.

6. The cold cathode field emission device according to claim 4, in which an insulating layer is formed on the support member and the cathode electrode, a gate electrode is formed on the insulating layer, a second opening portion communicating with an opening portion formed in the gate electrode is formed in the insulating layer, and the electron emitting portion is exposed in the bottom of the second opening portion.

7. The cold cathode field emission device according to claim 4, in which an electron-emitting-portion-forming layer is formed between the cathode electrode and the electron emitting portion.

8. The cold cathode field emission device according to claim 7, in which a gate electrode having an opening portion is further provided, the electron-emitting-portion-forming layer is formed at least on the surface of that portion of the cathode electrode which is positioned in the bottom of the opening portion, and the electron emitting portion is formed on the electron-emitting-portion-forming layer.

9. The cold cathode field emission device according to claim 7, in which an insulating layer is formed on the support member and the cathode electrode, the gate electrode is formed on the insulating layer, a second opening portion communicating with the opening portion formed in the gate electrode is formed in the insulating layer, and the electron emitting portion is exposed in the bottom of the second opening portion.

10. The cold cathode field emission device according to claim 7, in which the electron-emitting-portion-forming layer is formed of a metal thin layer.

11. The cold cathode field emission device according to claim 10, in which the metal thin layer is composed of at least one metal selected from the group consisting of nickel, molybdenum, titanium, chromium, cobalt, tungsten, zirconium, tantalum, iron, copper, platinum, zinc, cadmium, germanium, tin, lead, bismuth, silver, gold, indium and thallium.

12. The cold cathode field emission device according to claim 4, in which the value of H/(S/π)^{½} is 3 to 7 in which S is an area of bottom surface of the conical electron emitting portion and H is a height thereof.

13. A method for producing a cold cathode field emission device, comprising the steps of;
(a) forming a cathode electrode on a support member, and
(b) selectively forming a conical electron emitting portion made of carbon on the surface of the cathode electrode.

14. The method for producing a cold cathode field emission device according to claim 13, in which said step (b) is followed by forming a gate electrode having an opening portion over the electron emitting portion.

15. The method for producing a cold cathode field emission device according to claim 13, in which the method further comprises, between said steps (a) and (b), the steps of;
forming an insulating layer on the support member and the cathode electrode,
forming a gate electrode having an opening portion on the insulating layer, and
forming, in the insulating layer, a second opening portion communicating with the opening portion formed in the gate electrode,
wherein the conical electron emitting portion made of carbon is formed on the cathode electrode positioned in the bottom of the second opening portion in the step (b).

16. The method for producing a cold cathode field emission device according to claim 13, in which said step (b) is followed by the steps of;
forming an insulating layer on the support member and the electron emitting portion,
forming a gate electrode having an opening portion on the insulating layer, and
forming, in the insulating layer, a second opening portion which communicates with the opening portion formed in the gate electrode and in a bottom of which the electron emitting portion is exposed.

17. The method for producing a cold cathode field emission device according to claim 13, in which the step of forming the conical electron emitting portion made of carbon is carried out on the basis of a plasma chemical vapor deposition method under a condition satisfying a plasma density of at least 10¹⁶m⁻³ in a state where a bias voltage is applied to the support member.

18. The method for producing a cold cathode field emission device according to claim 17, in which the plasma CVD method is selected from an inductively coupled plasma CVD method, an electron cyclotron resonance plasma CVD method, a helicon wave plasma CVD method or a capacitively coupled plasma CVD method.

19. The method for producing a cold cathode field emission device according to claim 17, in which in the step of forming the conical electron emitting portion made of carbon, the temperature for heating the support member is set at 500° C. or lower.

20. The method for producing a cold cathode field emission device according to claim 13, in which the step of forming the conical electron emitting portion made of carbon is carried out on the basis of a plasma CVD method under a condition satisfying an electron temperature of 1 to 15 eV and an ion current density of 0.1 mA/cm² to 30 mA/cm² in a state where a bias voltage is applied to the support member.

21. The method for producing a cold cathode field emission device according to claim 20, in which the plasma CVD method is selected from an inductively coupled plasma CVD method, an electron cyclotron resonance plasma CVD method, a helicon wave plasma CVD method or a capacitively coupled plasma CVD method.

22. The method for producing a cold cathode field emission device according to claim 20, in which in the step of forming the conical electron emitting portion made of carbon, the temperature for heating the support member is set at 500° C. or lower.

23. A method for producing a cold cathode field emission device, comprising the steps of;
(a) forming a cathode electrode on a support member,
(b) forming an electron-emitting-portion-forming layer on the cathode electrode, and
(c) forming a conical electron emitting portion made of carbon on the electron-emitting-portion-forming layer.

24. The method for producing a cold cathode field emission device according to claim 23, in which the method further comprises, between said steps (b) and (c), the step of forming a gate electrode having an opening portion above the electron-emitting-portion-forming layer,
wherein the conical electron emitting portion made of carbon is formed on the electron-emitting-portion-forming layer under the opening portion in the step (c).

25. The method for producing a cold cathode field emission device according to claim 23, in which the method further comprises, between said steps (b) and (c), the step of;
forming an insulating layer on the support member and the electron-emitting-portion-forming layer,
forming a gate electrode having an opening portion on the insulating layer, and
forming, in the insulating layer, a second opening portion communicating with the opening portion formed in the gate electrode,
wherein the conical electron emitting portion made of carbon is formed on the electron-emitting-portion-forming layer positioned in the bottom of the second opening portion in the step (c).

26. The method for producing a cold cathode field emission device according to claim 23, in which the method comprises, between said steps (a) and (b), the steps of;
forming an insulating layer on the support member and the cathode electrode,
forming a gate electrode having an opening portion on the insulating layer, and
forming, in the insulating layer, a second opening portion communicating with the opening portion formed in the gate electrode,
wherein the electron-emitting-portion-forming layer is formed on the cathode electrode positioned in the bottom of the second opening portion in the step (b).

27. The method for producing a cold cathode field emission device according to claim 23, in which the step (c) is followed by the step of forming a gate electrode having an opening portion over the electron emitting portion.

28. The method for producing a cold cathode field emission device according to claim 23, in which the step (c) is followed by the steps of;
forming an insulating layer on the support member and the electron emitting portion,
forming a gate electrode having an opening portion on the insulating layer, and
forming, in the insulating layer, a second opening portion which communicates with the opening portion formed in the gate electrode and in a bottom of which the electron emitting portion is exposed.

29. The method for producing a cold cathode field emission device according to claim 23, in which the step of forming the conical electron emitting portion made of carbon is carried out on the basis of a plasma CVD method under a condition satisfying a plasma density of at least 10¹⁶m⁻³ in a state where a bias voltage is applied to the support member.

30. The method for producing a cold cathode field emission device according to claim 29, in which the plasma CVD method is selected from an inductively coupled plasma CVD method, an electron cyclotron resonance plasma CVD method, a helicon wave plasma CVD method or a capacitively coupled plasma CVD method.

31. The method for producing a cold cathode field emission device according to claim 29, in which in the step of forming the conical electron emitting portion made of carbon, the temperature for heating the support member can be set at 500° C. or lower.

32. The method for producing a cold cathode field emission device according to claim 23, in which the step of forming the conical electron emitting portion made of carbon is carried out on the basis of a plasma CVD method under a condition satisfying an electron temperature of 1 to 15 eV and an ion current density of 0.1 mA/cm² to 30 mA/cm² in a state where a bias voltage is applied to the support member.

33. The method for producing a cold cathode field emission device according to claim 32, in which the plasma CVD method is selected from an inductively coupled plasma CVD method, an electron cyclotron resonance plasma CVD method, a helicon wave plasma CVD method or a capacitively coupled plasma CVD method.

34. The method for producing a cold cathode field emission device according to claim 32, in which in the step of forming the conical electron emitting portion made of carbon, the temperature for heating the support member can be set at 500° C. or lower.

35. The method for producing a cold cathode field emission device according to claim 23, in which the electron-emitting-portion-forming layer is formed of a metal thin layer.

36. The method for producing a cold cathode field emission device according to claim 35, in which the electron-emitting-portion-forming layer is formed by a physical vapor deposition method or a plating method.

37. The method for producing a cold cathode field emission device according to claim 35, in which the metal thin layer is composed of at least one metal selected from the group consisting of nickel, molybdenum, titanium, chromium, cobalt, tungsten, zirconium, tantalum, iron, copper, platinum, zinc, cadmium, germanium, tin, lead, bismuth, silver, gold, indium and thallium.

38. The method for producing a cold cathode field emission device according to claim 23, in which after the formation of the electron-emitting-portion-forming layer, an oxide on the surface of the electron-emitting-portion-forming layer is removed.

39. The method for producing a cold cathode field emission device according to claim 38, in which the oxide is removed by a plasma reduction treatment or a washing treatment.

40. A cold cathode field emission display comprising a plurality of pixels,
each pixel being composed of a cold cathode field emission device formed on a support member, an anode electrode and a phosphor layer, said anode electrode and said phosphor layer being formed on a substrate to be opposed to the cold cathode field emission device,
said cold cathode field emission device comprising;
(A) a cathode electrode formed on the support member, and
(B) a conical electron emitting portion made of carbon and formed on the cathode electrode.

41. The cold cathode field emission display according to claim 40, in which the cold cathode field emission device further has a gate electrode having an opening portion, and the electron emitting portion is formed on that portion of the cathode electrode which is positioned in the bottom of the opening portion.

42. The cold cathode field emission display according to claim 40, in which an insulating layer is formed on the support member and the cathode electrode, a gate electrode is formed on the insulating layer, a second opening portion communicating with an opening portion formed in the gate electrode is formed in the insulating layer, and the electron emitting portion is exposed in the bottom of the second opening portion.

43. The cold cathode field emission display according to claim 40, in which an electron-emitting-portion-forming layer is formed between the cathode electrode and the electron emitting portion.

44. The cold cathode field emission display according to claim 43, in which the cold cathode field emission device further has a gate electrode having an opening portion, the electron-emitting-portion-forming layer is formed at least on the surface of that portion of the cathode electrode which is positioned in the bottom of the opening portion, and the electron emitting portion is formed on the electron-emitting-portion-forming layer.

45. The cold cathode field emission display according to claim 43, in which an insulating layer is formed on the support member and the cathode electrode, the gate electrode is formed on the insulating layer, a second opening portion communicating with the opening portion formed in the gate electrode is formed in the insulating layer, and the electron emitting portion is exposed in the bottom of the second opening portion.

46. The cold cathode field emission display according to claim 43, in which the electron-emitting-portion-forming layer is formed of a metal thin layer.

47. The cold cathode field emission display according to claim 46, in which the metal thin layer is composed of at least one metal selected from the group consisting of nickel, molybdenum, titanium, chromium, cobalt, tungsten, zirconium, tantalum, iron, copper, platinum, zinc, cadmium, germanium, tin, lead, bismuth, silver, gold, indium and thallium.

48. The cold cathode field emission display according to claim 40, in which the value of H/(S/π)^{½} is 3 to 7 in which S is an area of bottom surface of the conical electron emitting portion and H is a height thereof.

49. A method for producing a cold cathode field emission display, comprising arranging a substrate having an anode electrode and a phosphor layer and a support member having a cold cathode field emission device such that the phosphor layer or the anode electrode and the cold cathode field emission device face each other and bonding the substrate and the support member in their circumferential regions,
wherein the cold cathode field emission device is formed by the steps of;
(a) forming a cathode electrode on the support member, and
(b) selectively forming a conical electron emitting portion made of carbon on the cathode electrode.

50. A method for producing a cold cathode field emission display, comprising arranging a substrate having an anode electrode and a phosphor layer and a support member having a cold cathode field emission device such that the phosphor layer or the anode electrode and the cold cathode field emission device face each other and bonding the substrate and the support member in their circumferential regions,
wherein the cold cathode field emission device is formed by the steps of;
(a) forming a cathode electrode on the support member,
(b) forming an electron-emitting-portion-forming layer on the cathode electrode, and
(c) forming a conical electron emitting portion made of carbon on the electron-emitting-portion-forming layer.
